(19) United States
(12) Patent Application Publication
(10) Pub. No.: US 2008/0270180 A1
(43) Pub. Date: Oct. 30, 2008

(54) Method and system for health care data transfer

(75) Inventors: Steven A. Sholtis, El Dorado Hills, CA (US); Kenneth J. Henderson, Folsom, CA (US); Terry F. LeClair, Fremont, CA (US); Maureen Costello, Clarence, NY (US); Reza Ghanbari, Wayzata, MN (US); Ramaswamy Sastri, Shakopee, MN (US); Carl Stanley Lestor, Maple Grove, MN (US)

Correspondence Address: OSHA - LIANG L.L.P. (INTUIT), 1221 MCKINNEY STREET, SUITE 2800, HOUSTON, TX, 77010, US

(73) Assignees: Intuit Inc., Mountain View, CA (US); Ingenix Inc., Eden Prairie, MN (US)

(21) Appl. No.: 11/799,170

(22) Filed: Apr. 30, 2007

(51) Int. Cl. G06Q 50/00

(52) U.S. Cl. 705/2

(57) ABSTRACT

A method for transferring health care data between a consumer health care application and a plurality of health care information sources. The method includes requesting a first portion of health care data corresponding to a consumer from a first health care information source of the plurality of health care information sources, receiving the first portion of health care data from the first health care information source, storing the first portion of health care data in a health care data repository, requesting a second portion of health care data corresponding to the consumer from a second health care information source of the plurality of health care information sources, receiving the second portion of health care data from the second health care information source, storing the second portion of health care data in the health care data repository, and accessing the first portion of health care data and the second portion of health care data from the health care data repository.

### BACKGROUND

A consumer typically manages many aspects of health care. As the consumer performs various management tasks related to health care (e.g., deciding whether to subscribe to a health plan, monitoring payment of claims by health care plans, deciding on contributions to and/or withdrawals from a health care savings account, etc.), the consumer may use information from many different sources (e.g., health plan providers, financial institutions holding health savings accounts, health care service providers, etc.).

Some of the information that the consumer needs for health care management may be available to the consumer electronically from these sources. In addition, some of the sources may provide applications with limited capabilities that the consumer may use to access and manage the health care related information available from the source. For example, health plan providers maintain repositories of subscriber health plan data including health claims received from service providers, the status of payments made to these providers under subscriber benefit plans, subscriber coverage and limits, etc. Many health plan providers also provide the capability for subscribers (i.e., consumers enrolled in a provided health plan) to access data. Specifically, the subscribers may view, and perhaps modify, some of the subscriber health care data regarding the subscribers' health claims and benefit plans via applications provided on the health plan providers' web sites. For example, a subscriber may view the status of pending claims under a benefit plan provided by a health plan using such an application. Similarly, financial institutions may provide the capability for a consumer to view balances of health care savings accounts and to make electronic payments to health care providers from the accounts.

Other health care information that a consumer may need is available to the consumer via paper reports (e.g., bills, laboratory reports, etc.) or orally (e.g., telephone calls to/from health care providers) even though the information is maintained electronically by the information sources. Many of these information sources have the capability to electronically exchange relevant parts of the consumer's health care information with other information sources (e.g., a physician or dentist may electronically submit claims to a health plan provider for services provided to the consumer, a physician may electronically receive a report from a laboratory regarding tests performed for the consumer, etc.). Consumers are not able to electronically access or transfer such information.

### SUMMARY

In general, in one aspect, the invention relates to a method for transferring health care data between a consumer health care application and a plurality of health care information sources. The method includes requesting a first portion of health care data corresponding to a consumer from a first health care information source of the plurality of health care information sources, receiving the first portion of health care data from the first health care information source, storing the first portion of health care data in a health care data repository, requesting a second portion of health care data corresponding to the consumer from a second health care information source of the plurality of health care information sources, receiving the second portion of health care data from the second health care information source, storing the second portion of health care data in the health care data repository, and accessing the first portion of health care data and the second portion of health care data from the health care data repository.

In general, in one aspect, the invention relates to a method for transferring health care data between a consumer health care application and a health care information source. The method includes sending a first request message comprising a first request for performing a first action corresponding to a first portion of health care data, receiving a first response message corresponding to the first request message, wherein the first response message comprises a result of performing the first action, and processing the first response message, wherein the first request message and the first response message adhere to a health care data transfer protocol.

In general, in one aspect, the invention relates to a health care data transfer system including a health care information source configured to store a portion of health care data corresponding to a consumer, and a health care data access service operatively connected to the health care information source. The health care data access service includes functionality to send a request message including a request for performing an action corresponding to the portion of health care data to the health care information source, receive a response message corresponding to the request message, wherein the response message includes a result of performing the action, and process the response message, wherein the request message and the response message adhere to a health care data transfer protocol.

In general, in one aspect, the invention relates to a health care data transfer system including a first health care information source corresponding to a first health care business domain, wherein the first health care information source includes a first portion of health care data corresponding to a consumer, a second health care information source corresponding to a second health care business domain, wherein the second health care information source includes a second portion of health care data corresponding to the consumer, and a health care data access service operatively connected to the first health care information source and the second health care information source. The health care data access service includes functionality to receive the first portion of health care data and the second portion of health care data, and store the first portion of health care data and the second portion of health care data.

In general, in one aspect, the invention relates to a health care data transfer system including a health care data repository configured to store health care data corresponding to a plurality of consumers, wherein the health care data is received from a plurality of health care information sources, and a health care data import component configured to import the health care data from the plurality of health care information sources using messages adhering to a health care data transfer protocol.

In general, in one aspect, the invention relates to a computer readable medium having computer program code embodied therein for causing a computer system to transfer health care data between a consumer health care application and a plurality of health care information sources. The computer program code including program instructions to request a first portion of health care data corresponding to a consumer from a first health care information source of the plurality of health care information sources, receive the first portion of health care data from the first health care information source, store the first portion of health care data in a health care data repository, request a second portion of health care data corresponding to the consumer from a second health care information source of the plurality of health care information sources, receive the second portion of health care data from the second health care information source, store the second portion of health care data in the health care data repository, and access the first portion of health care data and the second portion of health care data from the health care data repository.

In general, in one aspect, the invention relates to a computer readable medium having computer program code embodied therein for causing a computer system to transfer health care data between a consumer health care application and a health care information source. The computer program code includes program instructions to send a first request message including a first request for performing a first action corresponding to a first portion of health care data, receive a first response message corresponding to the first request message, wherein the first response message includes a result of performing the first action, and processing the first response message, wherein the first request message and the first response message adhere to a health care data transfer protocol

Other aspects and benefits of the invention will be apparent from the following description and the appended claims.

### BRIEF DESCRIPTION OF DRAWINGS

FIG. 1 shows a diagram of a system in accordance with one or more embodiments of the invention.

FIG. 2 shows a health care data transfer (HCDT) request message and response message in accordance with one or more embodiments of the invention.

FIGS. 3-39 show HCDT topics and catalogs in accordance with one or more embodiments of the invention.

FIGS. 40A-40D show HCDT request/response message pairs in accordance with one or more embodiments of the invention.

FIGS. 41A-41B show call flows for the transfer of health care data in accordance with one or more embodiments of the invention.

FIG. 42-44 show flowcharts in accordance with one or more embodiments of the invention.

FIG. 45 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for health care data transfer between health care information sources and consumers. A consumer, as used herein, includes anyone that consumes health care services directly (e.g., a patient, employee, test subject, or other direct consumer of health care services) or indirectly (e.g., a health plan customer service representative, a medical professional, or other indirect consumer of health care services).

More specifically, in one or more embodiments of the invention, health care data may be transferred between health care information sources, a consumer health care application, and/or an intermediary health care data access service using a health care data transfer (HCDT) protocol. The HCDT protocol provides a standard for how a health care information source exposes health care data to consumer health care applications and/or an intermediary health care data access service. That is, the HCDT protocol defines the messages used to send and receive health care data and the data structures used in the messages to represent health care data in the health care business domains of the health care information sources. The health care business domains may include any aspect of consumer health care (e.g., a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, a psychology business domain, etc.).

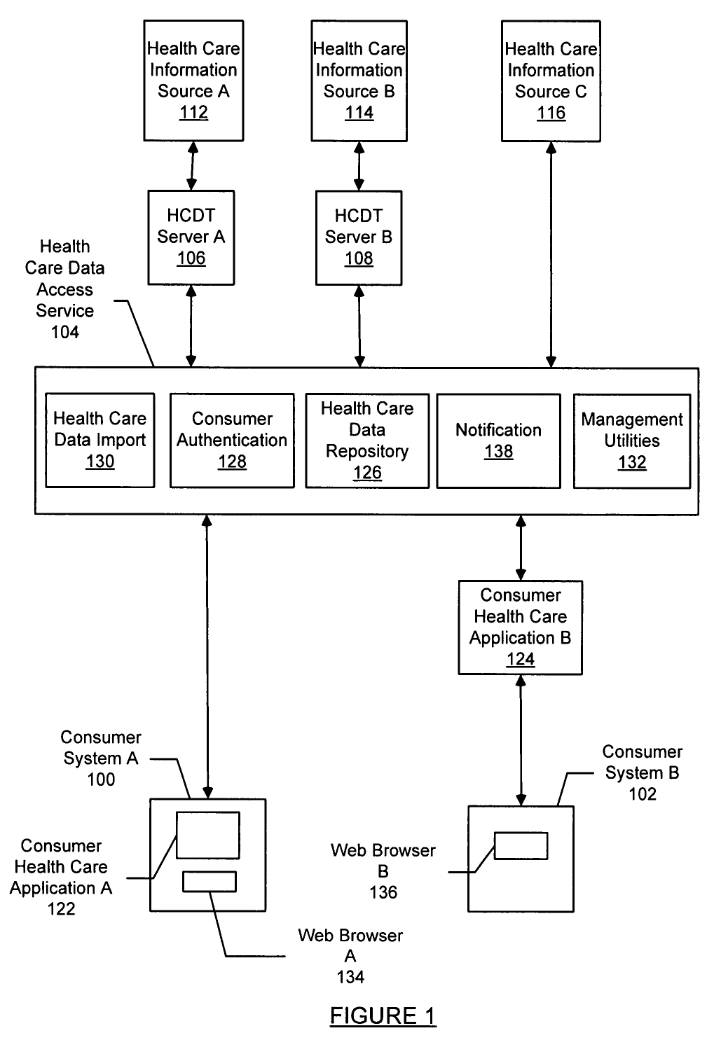

FIG. 1 shows a health care data transfer system in accordance with one or more embodiments of the invention. In one embodiment of the invention, the health care data transfer system includes one or more health care information sources (e.g., Health Care Information Source A (112), Health Care Information Source B (114), Health Care Information Source C (116)), one or more HCDT servers (e.g., HCDT Server A (106), HCDT Server A (108)), a health care data access service (e.g., Health Care Data Access Service (104)), and one or more consumer systems (e.g., Consumer System A (100), Consumer System B (102)). While only two consumer systems, two HCDT servers, and three health care information sources are shown in the system of FIG. 1 for simplicity of presentation and explanation, one of ordinary skill will appreciate that multiple consumer systems, HCDT servers, and health care information sources may be included.

In some embodiments of the invention, components of the health care data transfer system communicate with each other via a network (e.g., a wide area network (WAN) such as the Internet, a wireless network, a local area network (LAN) or a combination of networks). Each health care information source (e.g., Health Care Information Source A (112), Health Care Information Source B (114), Health Care Information Source C (116)) corresponds to a source of consumer health care information (e.g., a health plan provider such as Aetna, United Healthcare, Humana, etc., a financial institution, a health care provider such as a physician, dentist, pharmacist, hospital, or laboratory, etc.) and may be configured to store consumer health care data related to the business domain of the health care information source. For example, if the health care information source (e.g., Health Care Information Source A (112), Health Care Information Source B (114), Health Care Information Source C (116)) is a health plan provider, the consumer health care data may include health claim data from benefit claims (e.g., medical claims, dental claims, pharmacy claims, vision claims, etc.) submitted by or on behalf of members (i.e., consumers who are covered under a health plan offered by the health plan provider) to one or more benefit plans included in a health plan provided by the health plan provider.

Each health care information source (e.g., Health Care Information Source A (112), Health Care Information Source B (114), Health Care Information Source C (116)) may be configured to allow a health care data access service (e.g., Health Care Data Access Service (104)), with proper authentication, to download (i.e., import) health care data corresponding to one or more consumers. For example, if the health care information source is a health plan provider, the health care data access service (e.g., Health Care Data Access Service (104)) may download health plan data corresponding to one or more members. In one or more embodiments of the invention, the health care information source (e.g., Health Care Information Source A (112), Health Care Information Source B (114), Health Care Information Source C (116)) is configured to authenticate the health care data access service (e.g., Health Care Data Access Service (104)) according to member authentication information stored on the health care information source (e.g., Health Care Information Source A (112), Health Care Information Source B (114), Health Care Information Source C (116)) in accordance with the privacy and security requirements of the Health Insurance Portability and Accountability Act (HIPAA) in a manner known in the art before allowing the download of the health plan data associated with the member.

In one or more embodiments of the invention, the health care data access service (e.g., Health Care Data Access Service (104)) is configured to provide backend services (e.g., storage and retrieval of information) to a consumer health care application (e.g., Consumer Health Care Application A (122), Consumer Health Care Application B (124)) accessible by a consumer using a consumer system (e.g., Consumer System A (100), Consumer System B (102)). The health care data access service (e.g., Health Care Data Access Service (104)) is also configured to receive requests related to the health care data from the consumer health care application (e.g., Consumer Health Care Application A (122), Consumer Health Care Application B (124)) and to generate responses to those requests. The health care data access service (e.g., Health Care Data Access Service (104)) includes a health care data import component (130), a consumer authentication component (128), management utilities (132), a notification component (138), and a health care data repository (126).

In some embodiments of the invention, the health plan data import component (128) is configured to import health care data associated with consumers from each health care information source (e.g., Health Care Information Source A (112), Health Care Information Source B (114), Health Care Information Source C (116)) identified in each consumer's registration information (explained in more detail below) and to store the imported health care data in the health care data repository (126). In one or more embodiments of the invention, the health care data repository (126) may be, for example, a database, a file system, one or more data structures configured in the memory of the health care data access service (e.g., Health Care Data Access Service (104)), or a suitable combination thereof. In one or more embodiments of the invention, the health plan data import component (128) is configured to import only new health care data (i.e., health care data added to a health care information source (e.g., Health Care Information Source A (112), Health Care Information Source B (114), Health Care Information Source C (116)) since the last time health care data was imported). In addition, in one or more embodiments of the invention, the health plan data import component (130) is configured to import health care data from the health care information sources (e.g., Health Care Information Source A (112), Health Care Information Source B (114), Health Care Information Source C (116)) periodically (e.g., each night after midnight).

In one or more embodiments of the invention, the consumer authentication component (128) is configured to receive consumer registration information from a consumer health care application (e.g., Consumer Health Care Application A (122), Consumer Health Care Application B (124)). In some embodiments of the invention, the consumer authentication component (128) is configured to receive and store the consumer's registration information (i.e., the authentication information a consumer uses to access a health care information source (e.g., Health Care Information Source A (112), Health Care Information Source B (114), Health Care Information Source C (116)) and the authentication information the consumer uses to access the health care data access service (e.g., Health Care Data Access Service (104))). For example, the consumer's registration information may include a login name, a password, an account number and benefit plan identification information for each health care information source that has the consumer's health care data. In one or more embodiments of the invention, the consumer authentication component (128) is configured to submit the consumer's authentication information to a health care information source (e.g., Health Care Information Source A (112), Health Care Information Source B (114), Health Care Information Source C (116)) to gain access to health care data associated with the consumer.

In one or more embodiments of the invention, the management utilities (132) include functionality for the administration of the health care data access service (e.g., Health Care Data Access Service (104)). Such functionality may include, for example, functionality to view and control the state of the health care data access service (e.g., Health Care Data Access Service (104)), to maintain a log of critical errors, to maintain an access log per HIPAA requirements, to provide system usage metrics, and to purge old data.

In one or more embodiments of the invention, the notification component (138) includes functionality to notify a consumer registered with the health care data access service (e.g., Health Care Data Access Service (104)) of various events related to the consumer's health care data that may occur. For example, the notification component may include functionality to notify a consumer that the consumer's health care data is available after the consumer's initial registration with the health care data access service (e.g., Health Care Data Access Service (104)). The notification component (138) may also be include functionality to notify a consumer when new health care data for the consumer is received from one or more of the consumer's identified health care information sources. Further, in some embodiments of the invention, the notification component may be configured to receive a targeted notification from a health care information source and send the notification to one or more consumers. For example, a health care information source may want to advertise a new service to multiple consumers or notify multiple consumers of a special event (e.g., open enrollment). In one or more embodiments of the inventions, the notification component (138) may provide a notification to a consumer by sending an electronic mail message, sending a Short Message Service (SMS) message, displaying a message when the consumer logs into the consumer health care application (e.g., Consumer Health Care Application A (122), Consumer Health Care Application B (124)), and/or any other suitable notification means.

In one or more embodiments of the invention, the health care data access service (e.g., Health Care Data Access Service (104)) may include one or more servers (not specifically shown) configured to provide the functionality of the health care data access service (e.g., Health Care Data Access Service (104)). For example, one or more servers may be configured to import and store consumer health care data from the health care information sources (e.g., Health Care Information Source A (112), Health Care Information Source B (114), Health Care Information Source C (116)), and/or one or more servers may be configured to manage network traffic between other servers in the health care data access service (e.g., Health Care Data Access Service (104)) and consumer systems (e.g., Consumer System A (100), Consumer System B (102)). In addition, in one embodiment of the invention, one or more servers in the health care data access service (e.g., Health Care Data Access Service (104)) may be configured to host the Consumer Health Care Application B (124).

In one or more embodiments of the invention, the consumer health care application (e.g., Consumer Health Care Application A (122), Consumer Health Care Application B (124)) includes functionality to display consumer health care data to a consumer and receive requests related to the health care data from the consumer. The consumer health care application (e.g., Consumer Health Care Application A (122), Consumer Health Care Application B (124)) may also include functionality to send requests for consumer health plan data to the health care data access service (e.g., Health Care Data Access Service (104)) and to receive responses to those requests. In some embodiments of the invention, the Consumer Health Care Application B (124) may be installed on a web server and accessed by a consumer using a Web Browser B (136). In some embodiments of the invention, the Consumer Health Care Application A (124) may be installed on a Consumer System A (100). Furthermore, in some embodiments of the invention, the Consumer Health Care Application A (122) may be downloaded from a health care information source (e.g., Health Care Information Source A (112), Health Care Information Source B (114), Health Care Information Source C (116)) and installed on the Consumer System A (100).

In one or more embodiments of the invention, the consumer health care application (e.g., Consumer Health Care Application A (122), Consumer Health Care Application B (124)) is configured to register a consumer with the health care data access service (e.g., Health Care Data Access Service (104)). More specifically, in one or more embodiments of the invention, the consumer health care application is configured to receive registration information from the consumer that includes the consumer's authentication information for accessing the health care data access service (e.g., user identification and password). In addition, the consumer health care application is configured to receive the identities of the health care information sources that have the consumer's health care data and the consumer's authentication information for each health care information source. For example, if the health care information source is a health plan provider, the consumer's registration information may include the identifying information for the health plans to which the consumer subscribes and the consumer's authentication information for each health plan. In one or more embodiments of the invention, a consumer's authentication information may include a consumer's user identification and password for logging into an access interface (not specifically shown) of a health care information source (e.g., Health Care Information Source A (112), Health Care Information Source B (114), Health Care Information Source C (116)).

A consumer system (e.g., Consumer System A (100), Consumer System B (102)) may be a desktop computer, a laptop computer, a mobile device, such as a cell phone or personal digital assistant, or any other computing system suitable for using a consumer health care application (e.g., Consumer Health Care Application A (122), Consumer Health Care Application B (124)). In some embodiments of the invention, a consumer uses a web browser (Web Browser A (134), Web Browser B (136)), (e.g., Microsoft® Internet Explorer, Mozilla's Firefox, Opera Software's Opera, etc.) installed on the consumer system (e.g., Consumer System A (100), Consumer System B (102)) to access the consumer health care application (e.g., Consumer Health Care Application A (122), Consumer Health Care Application B (124)).

Although not specifically shown in FIG. 1, in some embodiments of the invention, a consumer health care application (e.g., Consumer Health Care Application A (122), Consumer Health Care Application B (124)) may be configured to communicate directly with one or more health care information sources (e.g., Health Care Information Source A (112), Health Care Information Source B (114), Health Care Information Source C (116)) to exchange health care data rather than or in addition to communicating with an intermediary such as the health care data access service (e.g., Health Care Data Access Service (104)) to exchange health care data. More specifically, some of the functionality of the health care data access service (e.g., Health Care Data Access Service (104)) may be included in a consumer health care application (e.g., Consumer Health Care Application A (122), Consumer Health Care Application B (124)). For example, a consumer health care application (e.g., Consumer Health Care Application A (122), Consumer Health Care Application B (124)) may include a health care data import component, a consumer authentication component, and a health care data repository specific to the consumer (i.e., that stores only the consumer's health care data).

In such embodiments, the consumer health care application (e.g., Consumer Health Care Application A (122), Consumer Health Care Application B (124)) is configured to import the consumer's health care data directly from the consumer's health care information sources and store the imported health care data in the health care data repository in the consumer health care application (e.g., Consumer Health Care Application A (122), Consumer Health Care Application B (124)). Further, in some embodiments of the invention, the health care data access service (e.g., Health Care Data Access Service (104)) may be configured to import and store health care data from the health care information sources (e.g., Health Care Information Source A (112), Health Care Information Source B (114), Health Care Information Source C (116)) that is common to multiple consumers (e.g., benefit claim code descriptions, pharmaceutical drug descriptions, etc.) and provide that information to consumer health care applications (e.g., Consumer Health Care Application A (122), Consumer Health Care Application B (124)) rather than requiring that each consumer health care application store and maintain such common health care data.

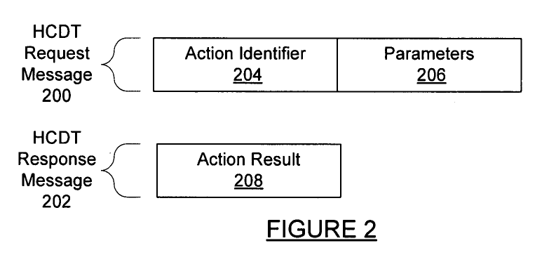

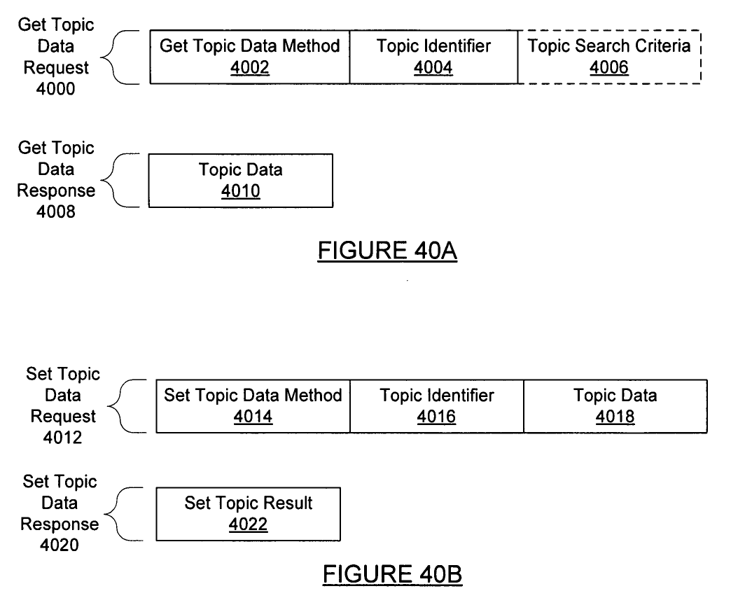

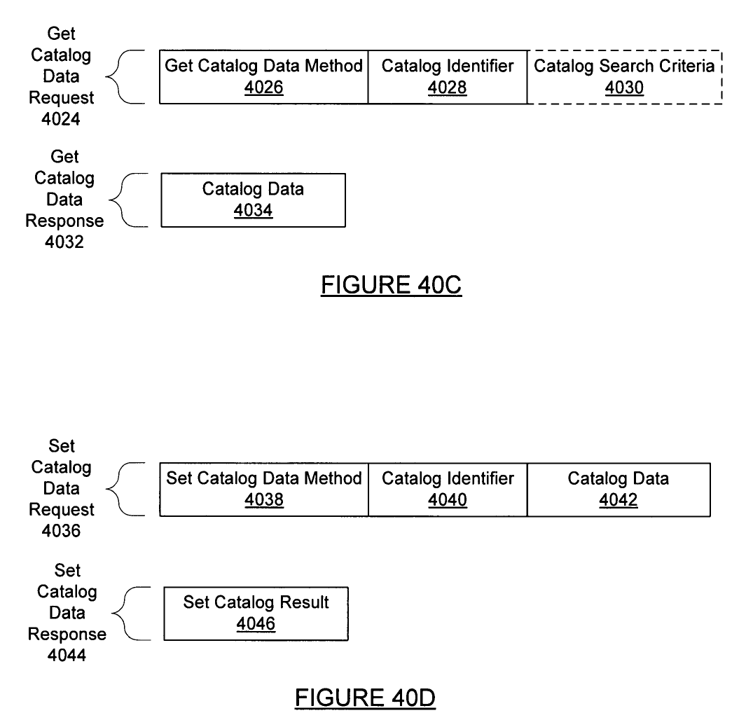

As is explained in more detail below in relation to FIG. 2 and FIGS. 40A-40D, in one or more embodiments of the invention, the HCDT protocol specifies that an action related to health care data (i.e., a request asking for health care data and a request asking for modifications to health care data) is communicated in a request message corresponding to the action. Further, the HCDT protocol specifies that the results of the action are communicated in a response message corresponding to the request message. In one or more embodiments of the invention, HCDT protocol messages are exchanged between the health care data access service (e.g., Health Care Data Access Service (104)) and the health care information sources (e.g., Health Care Information Source A (112), Health Care Information Source B (114), Health Care Information Source C (116)). In addition, in some embodiments of the invention, HCDT protocol messages are exchanged between a consumer health care application (e.g., Consumer Health Care Application A (122), Consumer Health Care Application B (124)) and the health care data access service (e.g., Health Care Data Access Service (104)) and/or the health care information sources (e.g., Health Care Information Source A (112), Health Care Information Source B (114), Health Care Information Source C (116)).

In some embodiments of the invention, a health care information source (e.g., Health Care Information Source C (116)) may be configured to use the HCDT protocol to receive messages and send responses to the health care data access service (e.g., Health Care Data Access Service (104)) and/or consumer health care applications (e.g., Consumer Health Care Application A (122), Consumer Health Care Application B (124)). Other health care information sources (e.g., Health Care Information Source A (112), Health Care Information Source B (114)) that do not support the HCDT protocol may be operatively connected to a HCDT server (e.g., HCDT Server A (106), HCDT Server A (108)) that serves as a HCDT interface for translating HCDT protocol messages into the message format(s) understood by the health care information source (e.g., Health Care Information Source A (112), Health Care Information Source B (114)) and vice versa.

That is, in one or more embodiments of the invention, the HCDT server (e.g., HCDT Server A (106), HCDT Server A (108)) is configured to receive an HCDT request message from another entity in the health care data transfer system (e.g., the health care data access service (e.g., Health Care Data Access Service (104)) or a consumer health care application (e.g., Consumer Health Care Application A (122), Consumer Health Care Application B (124))), determine what action is required based on the message, and translate that action into one or more requests to the corresponding health care information source (e.g., Health Care Information Source A (112), Health Care Information Source B (114)) in a format understood by the health care information source (e.g., Health Care Information Source A (112), Health Care Information Source B (114)). The HCDT server (e.g., HCDT Server A (106), HCDT Server A (108)) is also configured to receive the results of the one or more requests from the health care information source (e.g., Health Care Information Source A (112), Health Care Information Source B (114)), translate the results into an HCDT response message corresponding to HCDT request message including the results, and send the HCDT response message back to the requesting entity.

Furthermore, the HCDT server (e.g., HCDT Server A (106), HCDT Server A (108)) is configured to receive a request from the corresponding health care information source (e.g., Health Care Information Source A (112), Health Care Information Source B (114)), translate the request into an HCDT request message, and sent the HCDT request message to another HCDT conversant entity in the health care data transfer system. The HCDT server (e.g., HCDT Server A (106), HCDT Server A (108)) is also configured to receive the HCDT response message corresponding to the request message, translate the contents of the response message into one or messages in a format understood by the corresponding health care information source (e.g., Health Care Information Source A (112), Health Care Information Source B (114)), and send the one or more messages to the source.

In one or more embodiments of the invention, those components of the health care data transfer system configured to exchange health care data using the HCDT protocol (e.g., the health care data access service (e.g., Health Care Data Access Service (104)), the HCDT servers (e.g., HCDT Server A (106), HCDT Server A (108)), and the Health Care Information Source C (116)) include HCDT web services (not specifically shown) configured to perform the communication. As is explained in more detail below in reference to FIGS. 40A-40D, each HCDT web service is configured to receive HCDT request messages, cause the actions in the request messages to be performed, and return the results of performing the actions to the requesters in HCDT response messages corresponding to the HCDT request messages.

Further, each HCDT web service includes a definition of the data structures that may be used in the HCDT messages transmitted to and by that HCDT web service. Many of these data structures are specific to the health care business domain represented by the HCDT web service. More specifically, an HCDT web service corresponding to a health care information source (e.g., Health Care Information Source A (112), Health Care Information Source B (114), Health Care Information Source C (116)) includes data structure definitions specific to the health care business domain of the health care information source. For example, if a health care information source is a health plan provider, the corresponding HCDT web service includes data structure definitions corresponding to the health plan business domain. And, if a health care information source is a financial institution, the corresponding HCDT web service includes data structure definitions corresponding to the financial business domain.

In one or more embodiments of the invention, the health care data access service (e.g., Health Care Data Access Service (104)) may include one HCDT web service for each health care business domain of the health care information sources (e.g., Health Care Information Source A (112), Health Care Information Source B (114), Health Care Information Source C (116)) for exchanging health care data with those sources. Further, in those embodiments of the invention in which a consumer health care application (e.g., Consumer Health Care Application A (122), Consumer Health Care Application B (124)) communicates directly with the health care information sources (e.g., Health Care Information Source A (112), Health Care Information Source B (114), Health Care Information Source C (116)), the consumer health care application may also include one HCDT web service for each health care business domain. For example, if one health care information source corresponds to a health plan business domain and another corresponds to a financial business domain, the health care data access service (e.g., Health Care Data Access Service (104)) and/or the consumer health care application (e.g., Consumer Health Care Application A (122), Consumer Health Care Application B (124)) includes two HCDT web servers, one specific to the health plan business domain and one specific to the financial domain.

FIGS. 2 and 40A-40D show the formats of the HCDT protocol messages in accordance to one or more embodiments of the invention. As was previously explained, in the HCDT protocol, an action related to health care data (i.e., a request for health care data and a request for modifications to health care data) is communicated in a request message corresponding to the action. The result of the action is communicated in a response message corresponding to the request message. FIG. 2 shows the format of an HCDT request message (200) and the corresponding HCDT response message (202).

An HCDT request message (200) includes an action identifier (204) and parameters (206). The action identifier (204) uniquely identifies the action to be performed by the recipient of the HCDT request message (200). The parameters (206) include any additional information needed by the recipient to perform the requested action. An HCDT response message (202) includes an action result (208). The action result (208) contains the result of performing the requested action.

In one or more embodiments of the invention, the action identifier (204) may specify one of four actions: get (i.e., fetch) health care data corresponding to a health care topic or a health care catalog, or set (i.e., modify) health care data corresponding to a health care topic or a health care catalog. The term modify and any variations thereof as used herein to describe a set request includes both a change to existing health care data and the addition of new health care data. Health care topics and health care catalogs are explained in more detail below.

The health care topic or the health care catalog for which data is to be fetched is specified as one of the parameters (206) of a get request message. In addition, search criteria may be specified as one of the parameters (206) of a get request message. The search criteria may be used to further define the data to be fetched. For example, the search criteria may be a date range that specifies that only data that falls within the date range should be returned. Further, the action result (208) in the response message corresponding to a get request message may be a data structure containing the requested health care data or an indication that the requested get action was not completed (e.g., an exception). The data structure corresponds to the health care topic or health care catalog specified in the get request message.

The health care topic or the health care catalog to be modified is specified as one of the parameters (206) of a set request message. Further, a data structure corresponding to the specified health care topic or health care catalog that contains the data to be used to modify the health care topic or health care catalog is also included as one of the parameters (206) of a set request message. The action result (208) in the response message corresponding to a set request message may be an indication that the requested set action was completed successfully (e.g., an acknowledgement) or an indication that the requested set action was not completed (e.g., an exception).

The HCDT messages may be transmitted over the network to the intended recipient using one or more communication protocols (e.g., HyperText Transfer Protocol (HTTP), Transmission Control Protocol (TCP) and Internet Protocol (IP)). In some embodiments of the invention, an HCDT message is encoded using, for example, Extensible Markup Language (XML). The encoded HCDT message is then sent to the intended recipient using one or more of the communication protocols.

Prior to sending the encoded HCDT message, metadata is associated with the encoded HCDT message. The metadata corresponds to data that is required by the network communication protocols. For example, if the encoded HCDT message is sent using HTTP, one or more of the following pieces of metadata must accompany the encoded data: general-header data, request-header data, response-header data, and entity-header data.

The intended recipient, upon receipt of the encoded HCDT message and metadata, processes the encoded HCDT message using the metadata. Processing the encoded HCDT message typically includes sending the encoded data through the various layers (i.e., physical layer, network layer, transport layer, etc.) of the Open Systems Interconnection (OSI) model in the recipient using the metadata, decoding the encoded HCDT message using the metadata, and performing the specified action of the HCDT message to generate a result.

Once the result has been generated, the recipient performs the same steps described above with respect to initiating the transmission to send a response message including the result to the initiator. Specifically, the recipient encodes the response message, generates the necessary metadata, and sends the metadata and the encoded response message to the initiator using one or more communication protocols. In one or more embodiments of the invention, the request/response message exchange is in accordance with the Simple Object Access Protocol (SOAP).

In one or more embodiments of the invention, in the HCDT protocol, the health care data in each of the health care business domains of the health care information sources is categorized into topics and catalogs. These topics and catalogs define the data structures used for the exchange of health care data within a health care data transfer system. A topic is an addressable, logical categorization of related health care data and a catalog is an addressable, logical categorization of related topics that organizes topics into manageable groups. The topics and catalogs for a particular health care business domain define the groupings of health care data (i.e., data structures) that may be referenced in an HCDT message directed to a health care information source or a health care data access service having health care data in that health care business domain.

In general, topics and catalogs defined for a health care business domain are unique to the types of health care data found in that domain. For example, in a health plan business domain, the defined topics may include a medical claims topic, a pharmacy claims topic, a members topic, a benefit plans topic, etc. These topics are explained in more detail below. In addition, for example, a defined catalog in a health plan business domain may be a user catalog that includes a collection of topics for one user (e.g., a consumer using a consumer health care application). Such a catalog may include the medical claims topic, the pharmacy claims topic, the members topic, etc. and may be used in a HCDT message to retrieve or modify data for one user in the included topics rather than requiring a message for each topic.

Further, in one or more embodiments of the invention, the HCDT protocol includes a predefined set of topics and catalogs for each type of health care business domain found in a health care data transfer system. Each health care information source in the same health care business domain is required to communicate using all topics and catalogs in the predefined set for that domain to the extent the health care information source can provide the data represented by a topic or catalog. However, if a health care information source has no data corresponding to a topic or to an element of a topic, the health care information source may indicate that the topic or element is not supported if requested to provide the corresponding data. For example, in the health plan business domain, a health plan provider may provide medical benefits but not pharmacy benefits. Thus, the health plan provider has no data corresponding to pharmacy claims and the pharmacy claims topic and the elements corresponding to pharmacy claims in the user catalog is not supported by that health plan provider.

Further, in one or more embodiments of the invention, some instances of a health care business domain may have health care data that is exclusive to those instances. Thus, the HCDT protocol includes functionality to define additional topics and/or to extend the predefined topics and catalogs for that health care business domain to include the exclusive health care data.

In one or more embodiments of the invention, the HCDT protocol includes some topics and catalogs that are common across all health care business domains and are included in each predefined set of topics and catalogs for each type of health care business domain. More specifically, the HCDT protocol may include topics and catalogs related to exception handling in each of the predefined sets of topics and catalogs that provide a consistent way of communicating information regarding exceptions that occur when processing HCDT request messages.

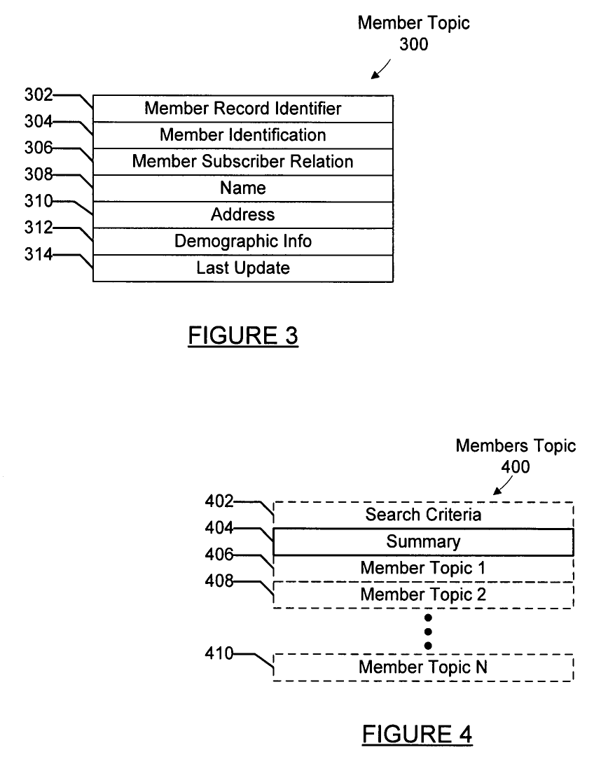

FIGS. 3-39 illustrate the topics and catalogs defined in the HCDT protocol for a health plan business domain in accordance with one or more embodiments of the invention. The topics and catalogs for this domain are defined specifically for transferring large amounts of data between a health plan provider and a health care data repository in a health care data access service. More specifically, in some embodiments of the invention, some of the defined topics may not be used standalone in HCDT request messages. Rather, these topics are used as subtopics of other topics and of catalogs that are defined to allow retrieval or modification of multiple such topics. For example, a medical claim topic defines the content of a single medical claim while a medical claims topic defines a data structure for retrieving multiple medical claims. This data structure may include multiple instances of the medical claim topic.

In FIGS. 3-39, entries of a topic or catalog enclosed in dotted lines are optional while those enclosed in sold lines are required. Further, in the descriptions of these figures below, unless specifically otherwise described, each data value in the described data structures may be in any representation suitable for representing the value. For example, an identifier may be a string, an integer, a name, or any other suitable value. In addition, unless otherwise noted below, those topics and catalogs that include search criteria may be used standalone in HCDT messages while those that do not include search criteria are subtopics.

FIG. 3 shows a member topic (300) in accordance with one or more embodiments of the invention. A member topic (300) represents information about a member of a health plan. A member of a health plan is a subscriber to the health plan or a dependent of the subscriber who is covered by the subscriber's health plan. A member topic (300) may include a member record identifier (302), member identification (304), member subscriber relation (306), name (308), address (310), demographic info (312), and last update (314).

A member record identifier (302) is a value that uniquely identifies the member record represented by the member topic (300). The member identification (304) includes information that uniquely identifies a member of a health plan. This information may include a member identifier that uniquely identifies a member and a data source system identifier that identifies the system within the health plan provider that generated the member identifier.

The member subscriber relation (306) includes information regarding a member's relationship to a subscriber. This information may include a code indicating the relationship and subscriber identification information that identifies the subscriber corresponding to the member. The subscriber identification information may include a subscriber identifier that uniquely identifies the subscriber and a data source system identifier that uniquely identifies the system within the health plan provider that generated the subscriber identifier.

The name (308) may include the member's last name, first name, middle name, and name suffix. The address (310) may include the member's current mailing address, city, county, state, zip code, country, province, and/or metropolitan statistical area (MSA) code. Demographic info (312) may include the member's date of birth and a gender code indicating the member's gender. Last update (314) is the date that the member information in the member topic (300) was last updated.

FIG. 4 shows a members topic (400) in accordance with one or more embodiments of the invention. A members topic (400) represents information about multiple members of a health plan. More specifically, a members topic (400) may be used to communicate information about a subscriber and the subscriber's dependents covered by the subscriber's health plan. A members topic (400) may include search criteria (402), a summary (404), and some number of member topics (406, 408, 410). The search criteria (402) include the search criteria used to locate the member topics included in the members topic. The search criteria (402) are included when the members topic (400) is returned in response message corresponding to a get request message that included search criteria. The search criteria (402) are not included when the members topic (400) is used in a set request message. When the members topic (400) is returned in response to a get request message, the summary (404) includes summary statistics for the member topics (406, 408, 410) retrieved. The summary statistics include the total number of member topics retrieved and may include a date range specified in the search criteria of the get request message. When the members topic (400) is used in a set request message, the summary must be included but the content of the summary is ignored.

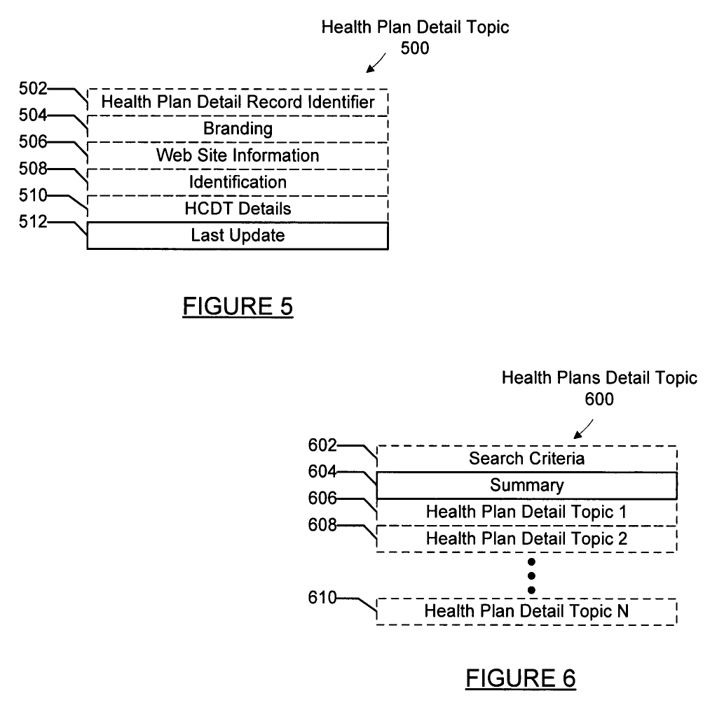

FIG. 5 shows a health plan detail topic (500) in accordance with one or more embodiments of the invention. A health plan detail topic (500) represents information about a health plan provided by a health plan provider. A health plan detail topic (500) may include a health plan detail record identifier (502), branding (504), web site information (506), identification (508), HCDT details (510), and a last update (512). A health plan detail record identifier (502) is a value that uniquely identifies the health plan detail record represented by the health plan detail topic (500). Branding (504) includes branding information for the health plan. The branding information may include a tag line, information that identifies labels for user security data fields, and logo details. The logo details include a uniform resource locator (URL) address of the logo and the image size of the logo.

Web site information (506) includes the URLs of the health plan home page, the health plan user preferences web page, the health plan email preferences web page, a claim details web page, a provider lookup web page, and a user authorization web page. Web site information (506) also includes information identifying how the health plan provider handles user support. The user support information may include a URL for a support web page, a telephone number, a fax number, one or more email addresses, and hours of operation of the support organization. Further, web site information (506) includes contact information for dispute resolution. The contact information includes one or more email addresses, a mailing address, and a URL for a dispute resolution web page. In some embodiments of the invention, the web site information may be used by a consumer health care application to provide the URLs and other information to a consumer.

Identification (508) includes a payer identifier, the name and address of the payer, and an organization label. A payer identifier uniquely identifies the payer organization for the health plan. An organization label is the name of the payer organization for the health plan. HCDT details (510) include details about the HCDT installation of the health plan provider. These details include version information and a URL of the health plan domain specification. Last update (512) may include the date that the information in the health plan detail topic (500) was last updated.

FIG. 6 shows a health plans detail topic (600) in accordance with one or more embodiments of the invention. A health plans detail topic (600) represents information about multiple health plans offered by a health plan provider. More specifically, a health plan provider may offer more than one health plan (e.g., a medical health plan, a pharmacy health plan, a dental health plan, a vision health plan, etc.). The health plans detail topic may be used to communicate information regarding the multiple health plans. A health plans detail topic (600) may include search criteria (602), a summary (604), and some number of health plan detail topics (606, 608, 610). The search criteria (602) include the search criteria used to select the health plan detail topics included in the health plans detail topic (600). The search criteria (602) are included when the health plans detail topic (600) is returned in response message corresponding to a get request message that included search criteria. The search criteria (602) are not included when the health plans detail topic (600) is used in a set request message. When the health plan details topic (600) is returned in response to a get request message, the summary (604) includes summary statistics for the health plan detail topics (606, 608, 610) retrieved. The summary statistics include the total number of health plan detail topics retrieved and may include a date range specified in the search criteria of the get request message. When the health plan details topic (600) is used in a set request message, the summary must be included but the content of the summary is ignored.

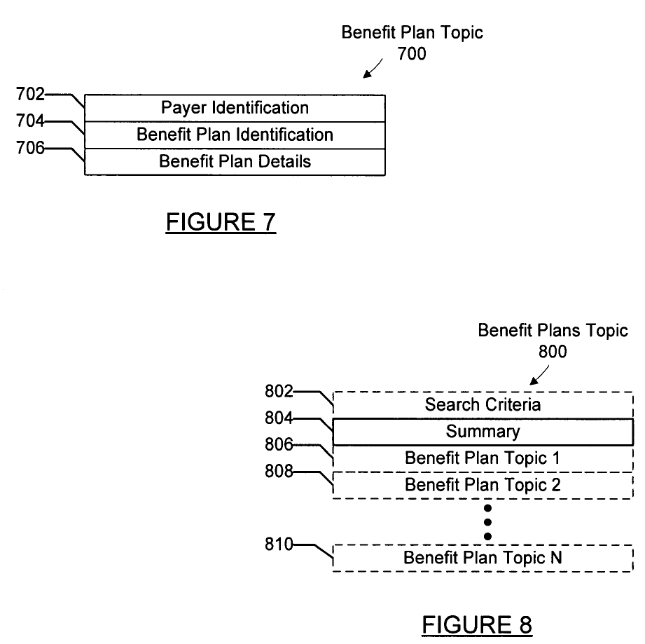

FIG. 7 shows a benefit plan topic (700) in accordance with one or more embodiments of the invention. A benefit plan topic (700) represents information about a benefit plan (e.g., HMO, PPO, etc.) offered by a health plan provider. A benefit plan may be a medical insurance plan, a dental insurance plan, a pharmacy insurance plan, a vision insurance plan, etc. A benefit plan topic (700) includes payer identification (702), benefit plan identification (704), and benefit plan details (706). Payer identification (702) includes a payer identifier that uniquely identifies the payer organization of the health plan provider for claims made under the benefit plan. Benefit plan identification (704) includes detailed information that uniquely identifies a benefit plan. This information includes a benefit plan identifier that uniquely identifies a benefit plan and a date on which the benefit plan starts.

Benefit plan details (706) includes a benefit plan record identifier that uniquely identifies the benefit plan record represented by the benefit plan topic (700), a short name for the benefit plan, a text description of the benefit plan, the date the benefit plan ends, and the date on which the information regarding the benefit plan became or will become valid. Benefit plan details (706) may also include the group name of the employer group covered by the benefit plan, the URL of the web site for the benefit plan, an identifier for the system within the health plan provider that generated the benefit plan record, and the date the benefit plan record was last updated.

FIG. 8 shows a benefit plans topic (800) in accordance with one or more embodiments of the invention. A benefit plans topic (800) represents information about multiple benefit plans of a health plan provider. A benefit plans topic (800) may include search criteria (802), a summary (804), and some number of benefit plan topics (806, 808, 810). The search criteria (802) include the search criteria used to select the benefit plan topics included in the benefit plans topic (800). The search criteria (802) are included when the benefit plans topic (800) is returned in response message corresponding to a get request message that included search criteria. The search criteria (802) are not included when the benefit plans topic (800) is used in a set request message. When the benefit plans topic (800) is returned in response to a get request message, the summary (804) includes summary statistics for the benefit plan topics (806, 808, 810) retrieved. The summary statistics include the total number of benefit plan topics retrieved and may include a date range specified in the search criteria of the get request message. When the benefit plans topic (800) is used in a set request message, the summary must be included but the content of the summary is ignored.

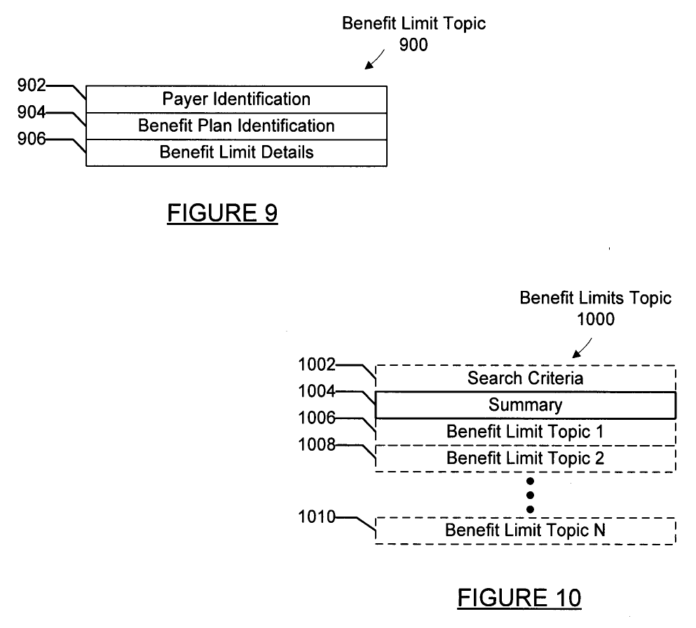

FIG. 9 shows a benefit limit topic (900) in accordance with one or more embodiments of the invention. A benefit limit topic (900) includes information about any limits on the coverage under a benefit plan. More specifically, a benefit limit topic (900) contains data about each patient responsibility amount (e.g., family deductible amount, individual deductible amount, family maximum out of pocket amount, etc.) that may be encountered by a member of a benefit plan. A benefit limits topic (900) includes payer identification (902), benefit plan identification (904), and benefit limit details (906). Payer identification (902) includes a payer identifier that uniquely identifies the payer organization of the health plan provider for claims made under the benefit plan to which the benefit limit applies. Benefit plan identification (904) includes detailed information that uniquely identifies the benefit plan to which the benefit limit applies.

Benefit limit details (906) may include a benefit limit record identifier that uniquely identifies the benefit limit record represented by the benefit limit topic (900) and a responsibility identifier that uniquely identifies the set of patient responsibility attributes that are associated with the benefit plan to which the benefit limit applies. Benefit limit details (906) may also include the patient responsibility type (e.g., co-pay, co-insurance, deductible, out of pocket, etc.) represented by the benefit limit topic (900), the dollar amount for the patient responsibility, if applicable, and the benefit percentage for the patient responsibility type, if applicable. Further, benefit limit details (906) may include a plan network indicator that indicates whether the patient responsibility values are considered to be in the benefit plan network or out of the benefit plan network. In addition, benefit limit details (906) may include a textual label associated with the patient responsibility, the type of coverage associated with the patient responsibility (e.g., medical, pharmacy, vision dental, etc.), an indication of whether the benefit limit is a family or an individual limit, and the date the benefit limit record was last updated.

FIG. 10 shows a benefit limits topic (1000) in accordance with one or more embodiments of the invention. A benefit limits topic (1000) represents information about multiple benefit limits under a benefit plan. A benefit limits topic (1000) may include search criteria (1002), a summary (1004), and some number of benefit limit topics (1006, 1008, 1010). The search criteria (1002) includes the search criteria used to select the benefit limit topics included in the benefit limits topic (1000). The search criteria (1002) are included when the benefit limits topic (1000) is returned in response message corresponding to a get request message that included search criteria. The search criteria (1002) are not included when the benefit limits topic (1000) is used in a set request message. When the benefit limits topic (1000) is returned in response to a get request message, the summary (1004) includes summary statistics for the benefit limit topics (1006, 1008, 1010) retrieved. The summary statistics include the total number of benefit limit topics retrieved and may include a date range specified in the search criteria of the get request message. When the benefit limits topic (1000) is used in a set request message, the summary must be included but the content of the summary is ignored.

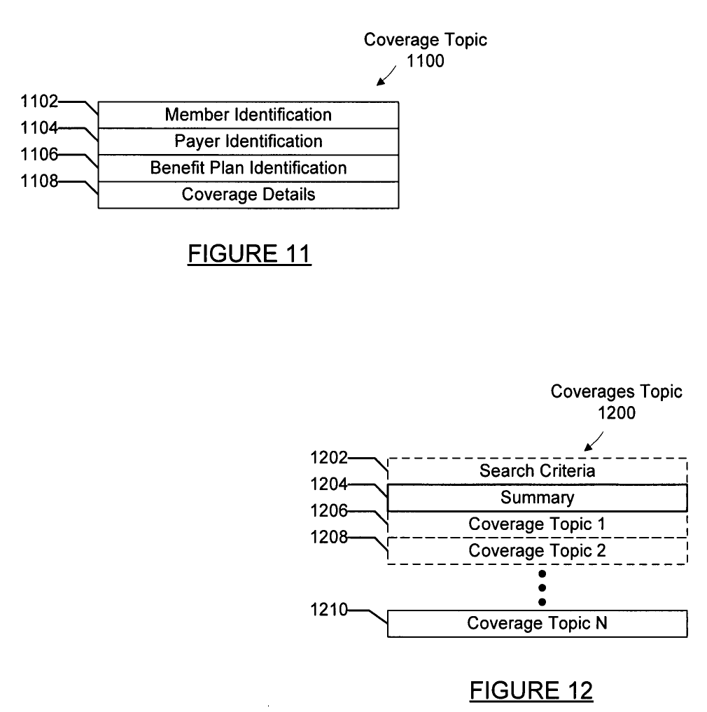

FIG. 11 shows a coverage topic (1100) in accordance with one or more embodiments of the invention. The coverage topic (1100) represents information about the coverage of a member under a benefit plan. A coverage topic (1100) includes member identification (1102), payer identification (1104), benefit plan identification (1106) and coverage details (1108). The member identification (1102) includes an identifier that uniquely identifies the member. Payer identification (1104) includes a payer identifier that uniquely identifies the payer organization of the health plan provider for claims made under the benefit plan. Benefit plan identification (1106) includes detailed information that uniquely identifies the benefit plan that provides the coverage. This information includes a benefit plan identifier that uniquely identifies the benefit plan and a date on which the benefit plan starts.

Coverage details (1108) include the details of a member's coverage. Coverage details (1108) may include a coverage record identifier that uniquely identifies the coverage record represented by the coverage topic (1100) and the effective start and end dates for the member's benefit coverage under the benefit plan. Coverage details (1108) may also include a medical coverage indicator, a pharmacy coverage indicator, a dental coverage indicator, and a vision coverage indicator. The value of each of these indicators denotes whether or not the benefit plan includes that coverage. In addition, coverage details (1108) may include the employer's identification number (i.e., group number) for the member or associated subscriber, the group name, contact information, and the date the coverage record was last updated.

FIG. 12 shows a coverages topic (1200) in accordance with one or more embodiments of the invention. A coverages topic (1200) represents information about multiple coverages of a subscriber. More specifically, a coverages topic (1200) may be used to communicate coverage information for a subscriber and the subscriber's dependents covered by a benefit plan. A coverages topic (1200) may include search criteria (1202), a summary (1204), and some number of coverage topics (1206, 1208, 1210). The search criteria (1202) include the search criteria used to select the coverage topics included in the coverages topic (1200). The search criteria (1202) are included when the coverages topic (1200) is returned in response message corresponding to a get request message that included search criteria. The search criteria (1202) are not included when the coverages topic (1200) is used in a set request message. When the coverages topic (1200) is returned in response to a get request message, the summary (1204) includes summary statistics for the coverage topics (1206, 1208, 1210) retrieved. The summary statistics include the total number of coverage topics retrieved and may include a date range specified in the search criteria of the get request message. When the coverages topic (1200) is used in a set request message, the summary must be included but the content of the summary is ignored.

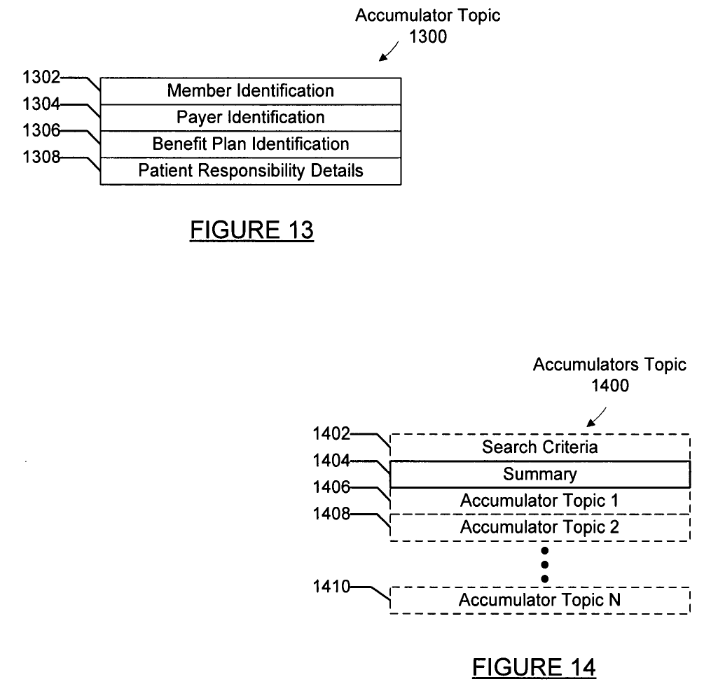

FIG. 13 shows an accumulator topic (1300) in accordance with one or more embodiments of the invention. An accumulator topic (1300) represents information about an accumulator of a member covered by a benefit plan. An accumulator is the accumulated dollar amount for a patient responsibility or a family responsibility. An accumulator topic (1300) includes member identification (1302), payer identification (1304), benefit plan identification (1306) and accumulator details (1308). The member identification (1302) includes an identifier that uniquely identifies the member. Payer identification (1304) includes a payer identifier that uniquely identifies the payer organization of the health plan provider for claims made under the benefit plan. Benefit plan identification (1306) includes detailed information that uniquely identifies the member's benefit plan. This information includes a benefit plan identifier that uniquely identifies the benefit plan and a date on which the benefit plan starts.

Patient responsibility details (1308) may include a patient responsibility record identifier that uniquely identifies the patient responsibility record represented by the accumulator topic (1300) and a responsibility identifier that uniquely identifies the set of patient responsibility attributes that are associated with the benefit plan. Patient responsibility details (1308) may also include the patient responsibility type (e.g., co-pay, co-insurance, deductible, out of pocket, etc.) represented by the accumulator topic (1300), a textual label associated with the patient responsibility type, and the type of coverage associated with the patient responsibility (e.g., medical, pharmacy, vision dental, etc.). In addition, patient responsibility details (1308) may include the current accumulated dollar amount for the patient responsibility and the date range in which the current dollar amount is calculated. Further, patient responsibility details (1308) may include a plan network indicator that indicates whether the patient responsibility values are considered to be in the benefit plan network or out of the benefit plan network and the date the patient responsibility record was last updated.

FIG. 14 shows an accumulators topic (1400) in accordance with one or more embodiments of the invention. An accumulators topic (1400) represents information about multiple accumulators of a subscriber. More specifically, an accumulators topic (1400) may be used to communicate the accumulators for a subscriber and the subscriber's dependents covered by a benefit plan. An accumulators topic (1400) may include search criteria (1402), a summary (1404), and some number of accumulator topics (1406, 1408, 1410). The search criteria (1402) include the search criteria used to select the accumulator topics included in the accumulators topic (1400). The search criteria (1402) are included when the accumulators topic (1400) is returned in response message corresponding to a get request message that included search criteria. The search criteria (1402) are not included when the accumulators topic (1400) is used in a set request message. When the accumulators topic (1400) is returned in response to a get request message, the summary (1404) includes summary statistics for the accumulator topics (1406, 1408, 1410) retrieved. The summary statistics include the total number of accumulator topics retrieved and may include a date range specified in the search criteria of the get request message. When the accumulators topic (1400) is used in a set request message, the summary must be included but the content of the summary is ignored.

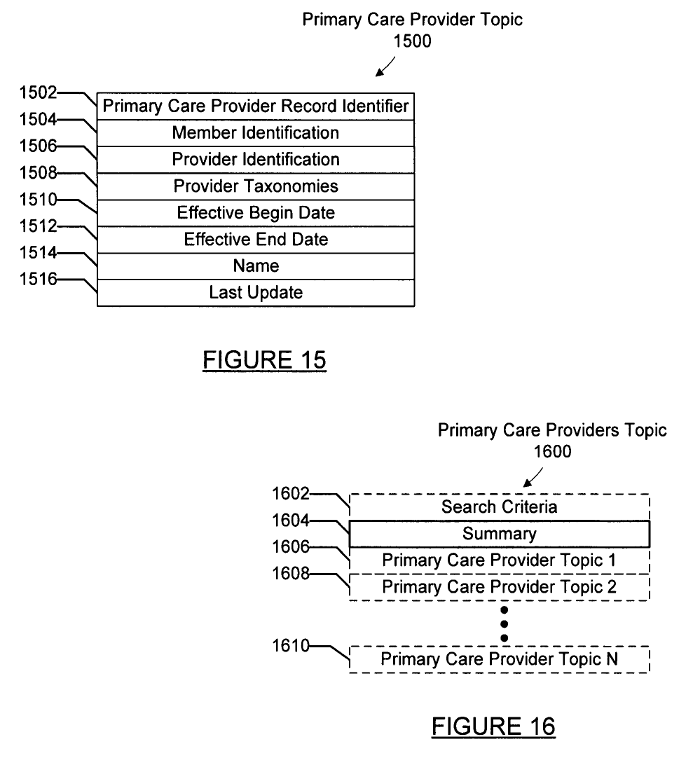

FIG. 15 shows a primary care provider topic (1500) in accordance with one or more embodiments of the invention. A primary care provider topic (1500) represents information about a physician that a member has selected as the member's primary care provider. A primary care provider topic (1500) includes a primary care provider record identifier (1502), member identification (1504), provider identification (1506), provider taxonomies (1508), effective begin date (1510), effective end data (1512), name (1514) and last update (1515). The primary care provider record identifier (1502) uniquely identifies the primary care provider record represented by the primary care provider topic (1500). The member identification (1504) includes an identifier that uniquely identifies the member.

The provider identification (1506) includes information that uniquely identifies the primary care provider. This information may include a provider identifier that uniquely identifies the primary care provider and a data source system identifier that identifies the system within the health plan provider that generated the primary care provider identifier. The provider taxonomies (1508) include information about the specialties of the primary care provider. This information may include a taxonomy code for each specialty of the primary care provider.

The effective begin date (1510) specifies the date on which the primary care provider is associated with the member. The effective end date (1512) specifies the date on which the primary care provider is no longer associated with the member. The name (1514) may include the primary care provider's last name, first name, middle name, and name suffix. Last update (1516) is the date that the primary care provider information in the primary care provider topic (1500) was last updated.

FIG. 16 shows a primary care providers topic (1600) in accordance with one or more embodiments of the invention. A primary care providers topic (1600) represents information about the primary care providers of a subscriber and the subscriber's covered dependents. A primary care providers topic (1600) may include search criteria (1602), a summary (1604), and some number of primary care primary care provider topics (1606, 1608, 1610). The search criteria (1602) include the search criteria used to select the primary care provider topics included in the primary care providers topic (1600). The search criteria (1602) is included when the primary care providers topic (1600) is returned in response message corresponding to a get request message that included search criteria. The search criteria (1602) are not included when the primary care providers topic (1600) is used in a set request message. When the primary care providers topic (1600) is returned in response to a get request message, the summary (1604) includes summary statistics for the primary care provider topics (1606, 1608, 1610) retrieved. The summary statistics include the total number of primary care provider topics retrieved and may include a date range specified in the search criteria of the get request message. When the primary care providers topic (1600) is used in a set request message, the summary must be included but the content of the summary is ignored.

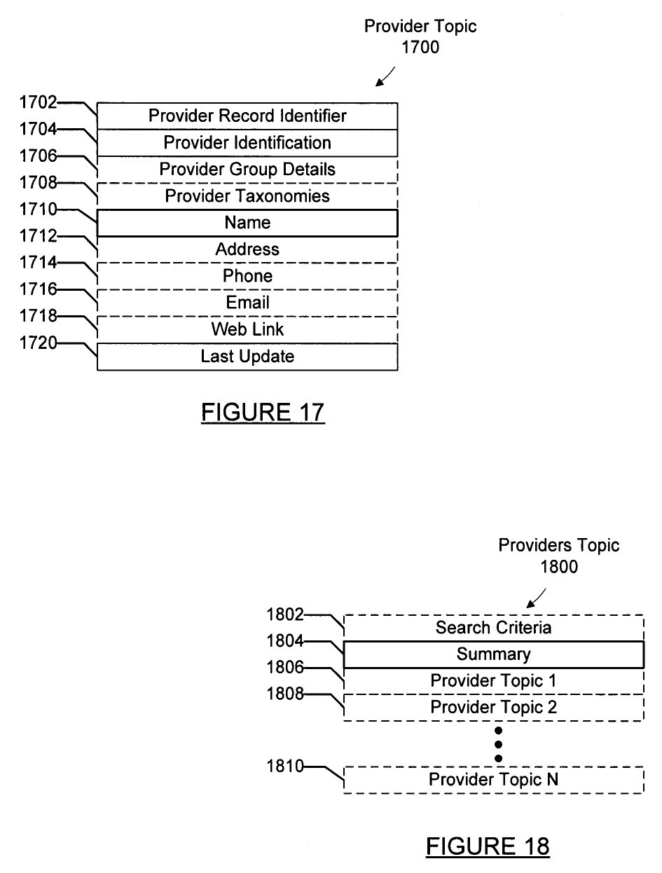

FIG. 17 shows a provider topic (1700) in accordance with one or more embodiments of the invention. A provider topic (1700) represents information about a service provider that may provide services to a member of a benefit plan. A provider topic (1700) may include a provider record identifier (1702), provider identification (1704), provider group details (1706), provider taxonomies 91708), name (1710), address (1712), phone (1714), email (1716), a web link (1718), and last update (1720). A provider record identifier (1702) is a value that uniquely identifies the provider record represented by the provider topic (1700).

The provider identification (1704) includes information that uniquely identifies the provider. This information may include a provider identifier that uniquely identifies the provider and a data source system identifier that identifies the system within the health plan provider that generated the provider identifier. The provider group details (1706) may include an identifier that uniquely identifies the group practice or clinic with which the provider is affiliated and the name of group practice or clinic. The provider group details (1706) may also include information as to whether the provider participates in the provider network of the health plan provider. The provider taxonomies (1708) include information about the specialties of the provider. This information may include a taxonomy code for each specialty of the provider.

The name (1710) may include the provider's last name, first name, middle name, and name suffix. The address (1712) may include the provider's current mailing address, city, county, state, zip code, country, province, and/or metropolitan statistical area (MSA) code. The phone (1714) may include the provider's telephone number. The email (1716) may include the provider's email address. The web link (1718) may include the URL of the provider's web site. Last update (1720) may include that date that the information in the provider topic (500) was last updated.

FIG. 18 shows a providers topic (1800) in accordance with one or more embodiments of the invention. A providers topic (1800) represents information about multiple service providers known to a health plan provider. A providers topic (1800) may include search criteria (1802), a summary (1804), and some number of primary care provider topics (1806, 1808, 1810). The search criteria (1802) include the search criteria used to select the provider topics included in the providers topic (1800). The search criteria (1802) are included when the providers topic (1800) is returned in response message corresponding to a get request message that included search criteria. The search criteria (1802) are not included when the providers topic (1800) is used in a set request message. When the providers topic (1800) is returned in response to a get request message, the summary (1804) includes summary statistics for the provider topics (1806, 1808, 1810) retrieved. The summary statistics include the total number of provider topics retrieved and may include a date range specified in the search criteria of the get request message. When the providers topic (1800) is used in a set request message, the summary must be included but the content of the summary is ignored.

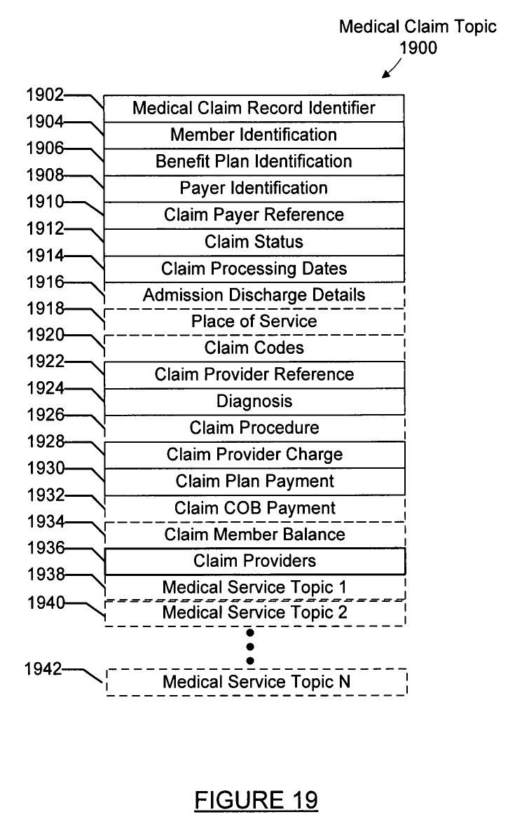

FIG. 19 shows a medical claim topic (1900) in accordance with one or more embodiments of the invention. A medical claim topic (1900) represents information about a single medical claim of a member. A medical claim topic (1900) includes a medical claim record identifier (1902), member identification (1904), benefit plan identification (1906), payer identification (1908), a claim payer reference (1910), claim status (1912) and claim processing dates (1914). A medical claim topic (1900) may also include admission discharge details (1916), a place of service (1918), and claim codes (1920). Further, a medical claim topic (1900) may include a claim provider reference (1922), diagnosis (1924), a claim procedure (1926), a claim provider charge (1928), a claim plan payment (1930), a claim coordination of benefits (COB) payment (1932), a claim member balance (1932), claim providers (1936), and one or more medical service topics (1938, 1940, 1942).

The medical claim record identifier (1902) uniquely identifies the medical claim record represented by the medical claim topic (1900). The member identification (1904) includes an identifier that uniquely identifies the member. Benefit plan identification (1906) includes detailed information that uniquely identifies the benefit plan associated with the medical claim. This information includes a benefit plan identifier that uniquely identifies the benefit plan and a date on which the benefit plan starts. Payer identification (1908) includes a payer identifier that uniquely identifies the payer organization of the health plan provider responsible for paying the medical claim.

The claim payer reference (1910) includes reference information regarding the medical claim that is intended for internal use by the payer of the claim. This information may include a payer claim control number that uniquely identifies services under an encounter or claim audit number or patient control number. The claim status (1912) includes information about the status of the medical claim. This information may include a claim status code that identifies the approval or denial status of the medical claim. The claim processing dates (1914) includes information regarding various dates the medical claim was processed. This information may include the date the medical claim record was last updated in the health care data repository, the beginning and ending dates of the period included on the medical claim, and the date the medical claim was received by the payer.

Admission discharge details (1916) include admission and discharge information related to the services included in the medical claim. This information may include a code indicating the priority of the admission, a code indicating the source of the admission, the admission date and time, and the discharge date and time. The place of service (1918) includes information about the place where a medical service included in the medical claim was performed for the member. This information may include a code identifying where the service was performed and a code that identifies the type of facility where the service was performed. This facility code may be the first and second positions of the Uniform Bill Type Code for Institutional Services or the Place of Service Code from the Electronic Media Claims National Standard format.

The claim codes (1920) include additional codes describing the claim. These codes may include a frequency code specifying the frequency of the claim, a patient status code indicating the member's status at the time of admission, outpatient service, or start of care, and a diagnosis related group code that represents the member's classification in a patient classification scheme that clusters patients into categories on the basis of illness, disease, and medical problems. The frequency code may be the third position of the Uniform Billing Claim Form Bill Type.

The claim provider reference (1922) includes reference information regarding the medical claim that is used internally by the service provider who submitted the claim. This information may include a number, code, or value that indicates the services provided for the medical claim were authorized by the payee and a medical record number that is uniquely assigned to the member by the provider for retrieval of the member's medical records.

The diagnosis (1924) includes information about the diagnosis associated with the services claimed in the medical claim. This information includes a principal diagnosis code that identifies the medical condition chiefly responsible for the claimed medical service and may also include one or more additional diagnosis codes identifying other conditions that co-existed at the time the medical service was rendered.

The claim procedure (1926) includes information about medical procedures performed as part of the services included in the medical claim. This information may include a principal ICD9 procedure code that identifies the procedure performed for definitive treatment rather than for diagnostic or exploratory purposes, or which was necessary to take care of a complication. This principal procedure is also the procedure most closely related to the principal diagnosis. The information may also include one or more additional ICD9 procedure codes that identify other procedures included in the medical claim. ICD-9 is an acronym used in the medical field that stands for International Classification of Diseases, ninth revision. The ICD9 codes are alphanumeric codes that represent any known disease or medical condition.

The claim provider charge (1928) includes information about the amounts charged by service providers associated with the medical claim. This information may include a claim charge amount that is the sum of all charges included in the medical claim. The claim plan payment (1930) includes information about payments made on the medical claim by the member's benefit plan. This information includes the amount paid by the payer on the medical claim and may include a payment indicator that indicates if the payment was made to the member or to the service provider.

The claim COB payment (1932) includes information about payments made on the medical claim by the member's other payer (i.e., another health plan provider of which the member is a member). This information may include a claim COB indicator that indicates if any payments on the medical claim involved coordination of benefits and the amount paid on the medical claim by the other payer. The claim member balance (1934) includes information about the amounts paid or payable by the member on the medical claim. This information may include a patient responsibility amount that is the amount of the claim charge that the member is responsible for paying.

The claim providers (1936) include information about any service providers that were involved in the medical services covered by the claim. This information may include provider information for the provider that referred the member to the rendering provider for the medical services, for the billing provider, and for the provider that rendered the medical services. The provider information may include the provider identification and the provider taxonomies. The provider identification includes information that uniquely identifies the provider. This information may include a provider identifier that uniquely identifies the provider and a data source system identifier that identifies the system within the health plan provider that generated the provider identifier. The provider taxonomies include information about the specialties of the provider. This information may include a taxonomy code for each specialty of the provider. For the rendering provider, the provider information may also include information as to whether the rendering provider participates in the provider network of the health plan provider.

The medical services topics (138, 1940, 1942) each represent information about a medical service included in the medical claim. A medical service topic is explained in more detail below in relation to FIG. 21.

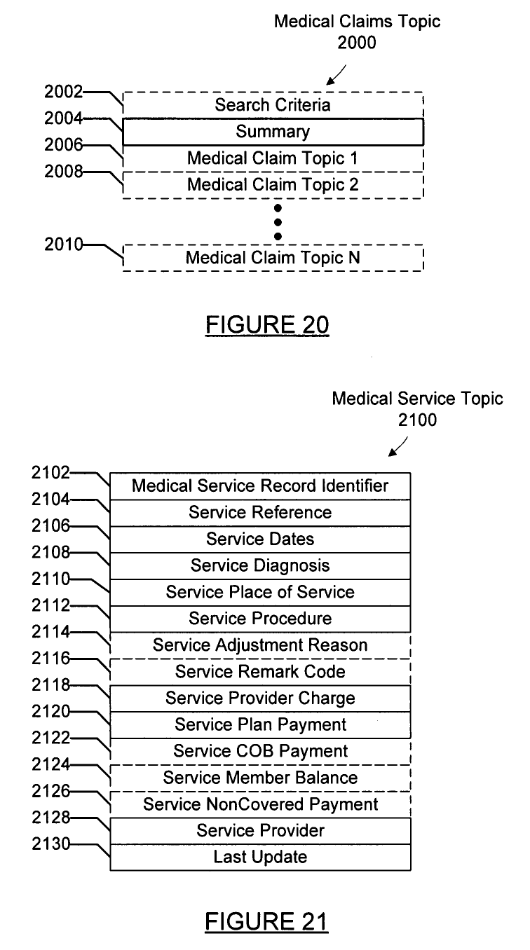

FIG. 20 shows a medical claims topic (2000) in accordance with one or more embodiments of the invention. A medical claims topic (2000) represents information about multiple medical claims. A medical claims topic (2000) may include search criteria (2002), a summary (2004), and some number of primary care medical claim topics (2006, 2008, 2010). The search criteria (2002) include the search criteria used to select the medical claim topics included in the medical claims topic (2000). The search criteria (2002) are included when the medical claims topic (2000) is returned in response message corresponding to a get request message that included search criteria. The search criteria (2002) are not included when the medical claims topic (2000) is used in a set request message. When the medical claims topic (2000) is returned in response to a get request message, the summary (2004) includes summary statistics for the medical claim topics (2006, 2008, 2010) retrieved. The summary statistics include the total number of medical claim topics retrieved and may include a date range specified in the search criteria of the get request message. When the medical claims topic (2000) is used in a set request message, the summary must be included but the content of the summary is ignored.

FIG. 21 shows a medical service topic (2100) in accordance with one or more embodiments of the invention. A medical service topic (2100) includes information about a medical service included in a medical claim. A medical service topic (2100) may include a medical service record identifier (2102), a service reference (2104), service dates (2106), a service diagnosis (2108), a service place of service (2110), and a service procedure (2112). A medical services topic (2100) may also include a service adjustment reason (2114), a service remark code (2116), a service provider charge (2118), a service plan payment (2120), and a service COB payment (2122). In addition, a medical services topic (2100) may include a service member balance (2124), a service noncovered payment (2126), a service provider (2128) and last update (2130).

The medical service record identifier (2102) uniquely identifies the medical service record represented by the medical service topic (1900). The service reference (2104) includes reference information regarding medical service that is intended for internal use by the payer of the medical claim including the medical service. This information may include a payer claim control service line number that uniquely identifies the service within a claim and a privacy restriction indicator that indicates if details regarding the service are omitted due to privacy restrictions.

The service dates (2106) includes information about various dates related to the medical service. This information may include the start and end dates of the medical service and the date of payment for the service or the date the payer denied payment for the medical service. The service diagnosis (2108) includes information about the diagnosis associated with the medical service. This information includes a principal diagnosis code that identifies the medical condition chiefly responsible for the medical service and may also include one or more additional diagnosis codes identifying other conditions that co-existed at the time the medical service was rendered.

The service place of service (2110) includes information about the place where the medical service was performed. This information may include a code identifying where the service was performed. The service procedure (2112) includes information about the medical service performed. This information may include a service line revenue code indicating a classification of hospital charges as defined by the National Uniform Billing Committee. This information may also include a procedure type code that identifies the type and source of the procedure code identifying the medical service, the procedure code, and one or more procedure modifiers that identify special circumstances related to the performance of the medical service. In addition, this information may include a service unit count that represents the number of service units approved by a pricing or re-pricing entity.

The service adjustment reason (2114) includes information about why an adjustment was made to the medical service. This information may include one or more line item patient responsibility reason codes and/or one or more noncovered reason codes. A line item patient responsibility reason code is a code that indicates why the patient is responsible for paying to the medical service. A noncovered reason code indicates the reason some amount related to the medical service was denied or not covered.

The service remark code (2116) includes codes related to non-financial information regarding the adjudication of a claim including the medical service. These codes may include one or more remark codes representing the non-financial information and/or one or more custom information codes that are specific to the health plan provider processing a claim including the medical service.

The service provider charge (2118) includes the amount charged by the service provider for the medical service. The service plan payment (2120) includes information about payments made by a benefit plan for the medical service. This information may include the actual amount paid to the provider of the medical service and the amount saved on the medical service due to a contractual arrangement with the service provider. The service COB payment (2122) includes the amount paid the medical service under coordination of benefits.

The service member balance (2124) includes information about amounts payable or paid by a member for the medical service. This information may include a line item deductible amount that is the amount of the member's deductible applied to the charge for the medical service and a line item coinsurance amount that is the amount paid by the member's coinsurance for the medical service. This information may also include a line item copay amount that is the member's copay amount for the medical service and a line item patient responsibility amount that is the amount of the charge for the medical service that is determined to be the member's responsibility for paying.

The service noncovered payment (2126) includes the amount of charges related to the medical service that were denied or not covered. The service provider (2128) includes information about the provider that rendered the medical service. This information may include a provider identifier that uniquely identifies the service provider and a data source system identifier that identifies the system within the health plan provider that generated the service provider identifier. The provider taxonomies include information about the specialties of the provider. This information may include a taxonomy code for each specialty of the service provider. The last update (2130) is the date and time the medical service information was last updated in the health care data repository.

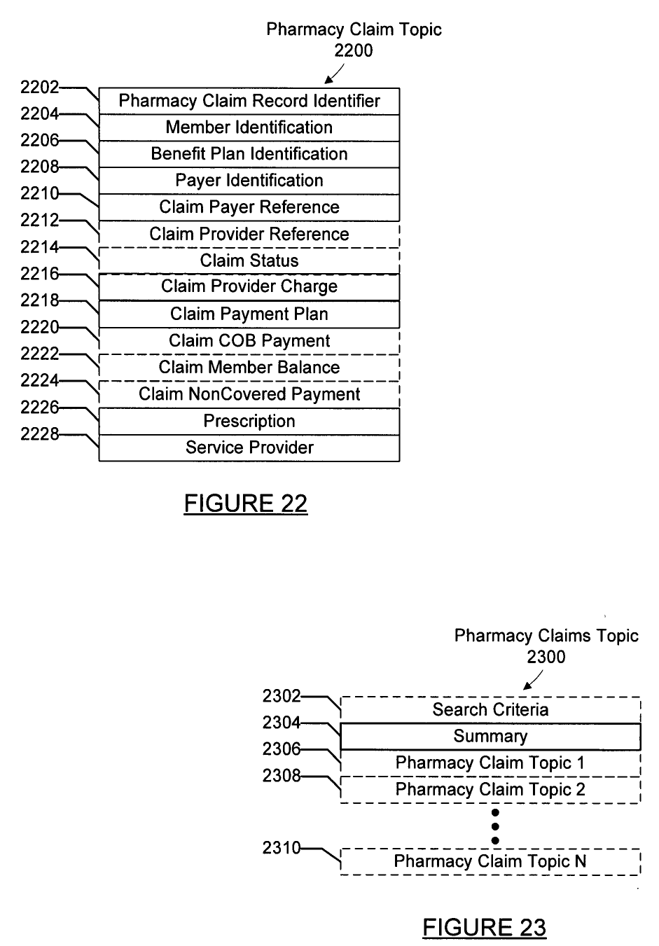

FIG. 22 shows a pharmacy claim topic (2200) in accordance with one or more embodiments of the invention. A pharmacy claim topic (2200) represents information about a single pharmacy claim of a member. A pharmacy claim topic (2200) may include a pharmacy claim record identifier (2202), member identification (2204), benefit plan identification (2206), payer identification (2208), claim payer reference (2210), and claim provider reference (2212). A pharmacy claim topic (2200) may also include claim status (2214), a claim provider charge (2216), a claim payment plan (2218), a claim COB payment (2220), a claim member balance (2222), a claim noncovered payment (224), a prescription (2226), and a service provider (2228).

The pharmacy claim record identifier (2202) uniquely identifies the pharmacy claim record represented by the pharmacy claim topic (2200). The member identification (2204) includes an identifier that uniquely identifies the member. Benefit plan identification (2206) includes detailed information that uniquely identifies the benefit plan associated with the pharmacy claim. This information includes a benefit plan identifier that uniquely identifies the benefit plan and a date on which the benefit plan starts. Payer identification (2208) includes a payer identifier that uniquely identifies the payer organization of the health plan provider responsible for paying the pharmacy claim.

The claim payer reference (2010) includes reference information regarding the pharmacy claim that is intended for internal use by the payer of the claim. This information may include a payer claim control number that uniquely identifies the pharmacy service under an encounter or claim audit number or patient control number. The claim provider reference (2212) includes reference information regarding the pharmacy claim that is used internally by the service provider who submitted the claim. This information may include a number, code, or value that indicates the services provided for the pharmacy claim were authorized by the payee and a pharmacy record number that is uniquely assigned to the member by the provider for retrieval of the member's pharmacy records.

The claim status (2214) includes codes related to non-financial information regarding the adjudication of the pharmacy claim. These codes may include one or more remark codes representing the non-financial information and/or one or more custom information codes that are specific to the health plan provider processing the pharmacy claim. The claim provider charge (2216) includes information about the amounts charged by service providers associated with the pharmacy claim. This information may include a claim charge amount that is the sum of all charges included in the pharmacy claim.

The claim plan payment (2218) includes information about payments made on the pharmacy claim by the member's benefit plan. This information includes the amount paid by the payer on the pharmacy claim and may include a payment indicator that indicates if the payment was made to the member or to the service provider. The claim COB payment (2220) includes information about payments made on the pharmacy claim by the member's other payer (i.e., another health plan provider of which the member is a member). This information may include a claim COB indicator that indicates if any payments on the pharmacy claim involved coordination of benefits and the amount paid on the pharmacy claim by the other payer.

The claim member balance (2222) includes information about the amounts paid or payable by the member on the pharmacy claim. This information may include a patient responsibility amount that is the amount of the claim charge that the member is responsible for paying. The service noncovered payment (2224) includes the amount of charges related to the pharmacy claim that were denied or not covered.

The prescription (2226) includes information about the member's prescription included in the pharmacy claim. This information may include the National Council for Prescription Drug Programs (NCPDP) provider identification number for the pharmacy that filled the prescription, the name of the dispensing pharmacy, and the eleven digit national drug code (NDC) for the prescribed drug. This information may also include a DAW (dispense as written) code that indicates whether or not the prescriber's instructions regarding generic substitution were followed, the estimated number of days the prescription will last, the quantity dispensed, and a code indicating whether the prescription is original or a refill. Further, this information may also include the date the prescription was filled, the date the prescription was written, and the date and time the prescription claim information was last updated in the health care data repository.

The service provider (2228) includes information about the provider that filled the prescription. This information may include a provider identifier that uniquely identifies the service provider and a data source system identifier that identifies the system within the health plan provider that generated the service provider identifier. The provider taxonomies include information about the specialties of the provider. This information may include a taxonomy code for each specialty of the service provider.

FIG. 23 shows a pharmacy claims topic (2300) in accordance with one or more embodiments of the invention. A pharmacy claims topic (2300) represents information about multiple pharmacy claims. A pharmacy claims topic (2300) may include search criteria (2302), a summary (2304), and some number of primary care pharmacy claim topics (2306, 2308, 2310). The search criteria (2302) include the search criteria used to select the pharmacy claim topics included in the pharmacy claims topic (2300). The search criteria (2302) are included when the pharmacy claims topic (2300) is returned in response message corresponding to a get request message that included search criteria. The search criteria (2302) are not included when the pharmacy claims topic (2300) is used in a set request message. When the pharmacy claims topic (2300) is returned in response to a get request message, the summary (2304) includes summary statistics for the pharmacy claim topics (2306, 2308, 2310) retrieved. The summary statistics include the total number of pharmacy claim topics retrieved and may include a date range specified in the search criteria of the get request message. When the pharmacy claims topic (2300) is used in a set request message, the summary must be included but the content of the summary is ignored.

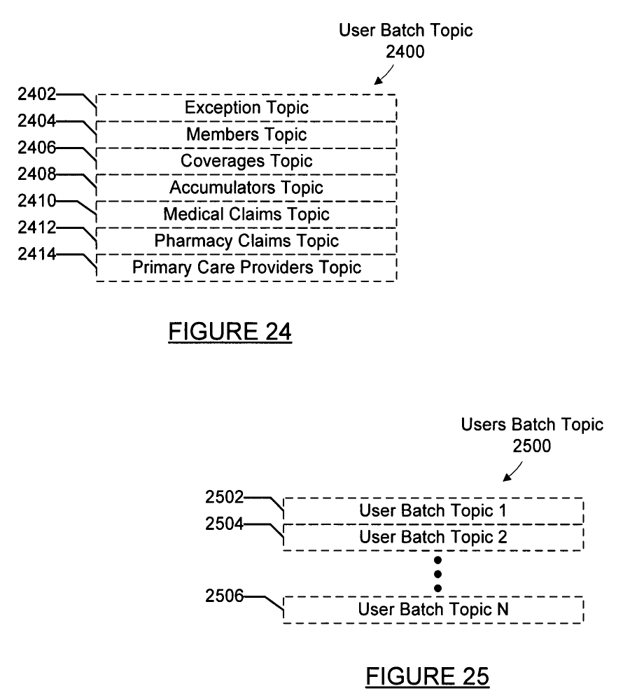

FIG. 24 shows a user batch topic (2400) in accordance with one or more embodiments of the invention. A user batch topic (2400) represents selected topics for a single user (i.e., a consumer that is registered with the health care data access service). The user batch topic is intended for use in a batch update of the health care data repository from a health plan provider. A user batch topic may include an exception topic (2402), a members topic (2404), a coverages topic (2406), an accumulators topic (2408), a medical claims topic (2410), a pharmacy claims topic (2412), and a primary care providers topic (2414). An exception topic (2402) may be present if an exception occurred in accessing any of the information in the user batch topic (2400) during a get request or a set request. An exception topic (2402) is described in more detail below in reference to FIG. 34. The formats of the other topics (2404-2414) are described in more detail above. Each of these topics (2404-2414) may include information as described above for the user and for each of the user's dependents who are members of one or more of the user's health care plans. For example, the medical claims topic (2410) may include medical claims for the user and the user's dependents.

FIG. 25 shows a users batch topic (2500) in accordance with one or more embodiments of the invention. A users batch topic (2500) includes information about multiple users of the health care data access service. More specifically, a users batch topic (2500) includes one or more user batch topics (2502-2506). Each user batch topic (2502-2506) represents information about a single user as described above. The users batch topic (2500) is used for bulk transfers of user data from a health plan provider to a health care data repository.

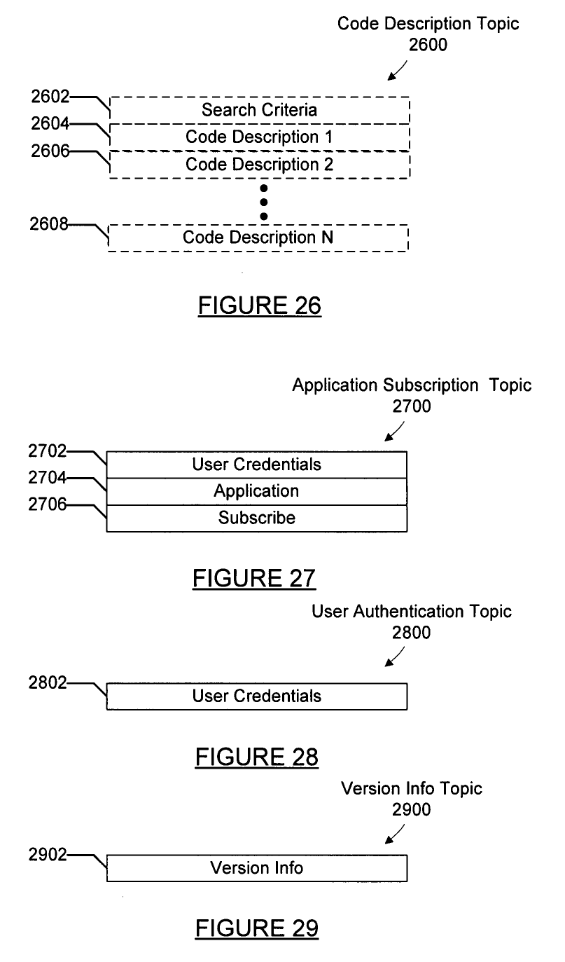

FIG. 26 shows a code description topic (2600) in accordance with one or more embodiments of the invention. A code description topic (2600) represents information about non-standard codes that may be used by a health plan provider. For example, a health plan provider may have a code for remarks included in a claim or a code for representing gender that differs from other health plan providers. The health care data access service may send a get request for this topic to the health plan provider to request descriptions of any non-standard codes used by the health plan provider. The search criteria used in the get request may be used to request descriptions for specific codes or for all codes. These search criteria may include payer identification that uniquely identifies the payer organization of the health plan provider, the code set, and one or more codes.

A code description topic includes search criteria (2602) and one or more code descriptions (2604, 2606, 2608). The search criteria (2602) include the search criteria used to locate the code descriptions (2604, 2606, 2608). A code description (2604, 2606, 2608) may include an identifier for the code and a description of the code.

FIG. 27 shows an application subscription topic (2700) in accordance with one or more embodiments of the invention. An application subscription topic (2700) represents the subscription status of a user accessing data from a health plan provider using an application. In one or more embodiments of the invention, the application may be any application configured to access health care data using the HCDT protocol. In some embodiments of the invention, the application may be a health care data access service. An application subscription topic (2700) includes user credentials (2702), application (2704), and subscribe (2706). User credentials (2702) include the elements required to authenticate the user with a health plan provider. These elements may include user identification and the user's password. The user identification may be a user name, sign-on name, an identifier selected or assigned via an authorization process with the health plan, or any other suitable type of identification. Application (2704) is a value that uniquely identifies the application. Subscribe (2706) is a value that indicates whether or not the user is subscribed to receive the user's health care data from the health plan provider through the application.

FIG. 28 shows a user authentication topic (2800) in accordance with one or more embodiments of the invention. A user authentication topic (2800) represents the information required to authenticate a user with a health plan. A user authentication topic (2800) includes user credentials (2802). User credentials (2802) include the elements required to authenticate the user with the user's health plan. These elements may include user identification and the user's password. The user identification may be a user name, sign-on name, an identifier selected or assigned via an authorization process with the health plan, or any other suitable type of identification.

FIG. 29 shows a version info topic (2900) in accordance with one or more embodiments of the invention. A version info topic (2900) represents information about the version of the HCDT protocol supported by a health plan provider. A version info topic (2900) includes version info (2902). Version info (2902) may include a version identifier, a revision level, the date the version was last modified, and the status of the version (i.e., pending, accepted, rejected, deferred, or deprecated). In one or more embodiments of the invention, this topic may be used to determine whether the version of the HCDT protocol supported by an HCDT server of a health plan provider is compatible with the version supported by a health care data access service.

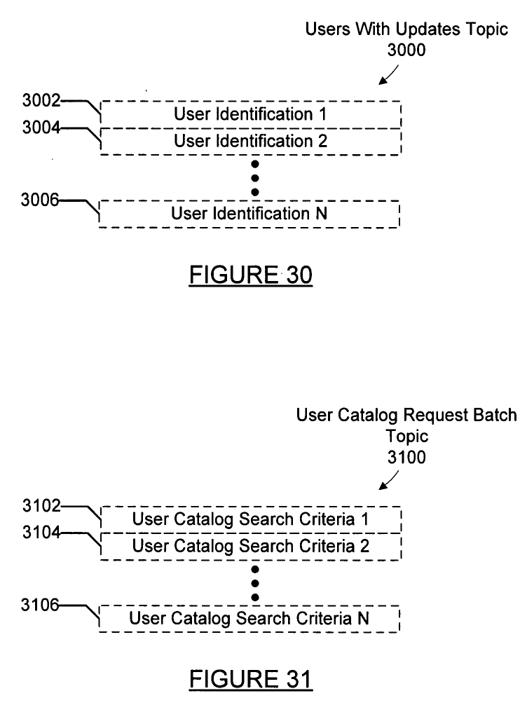

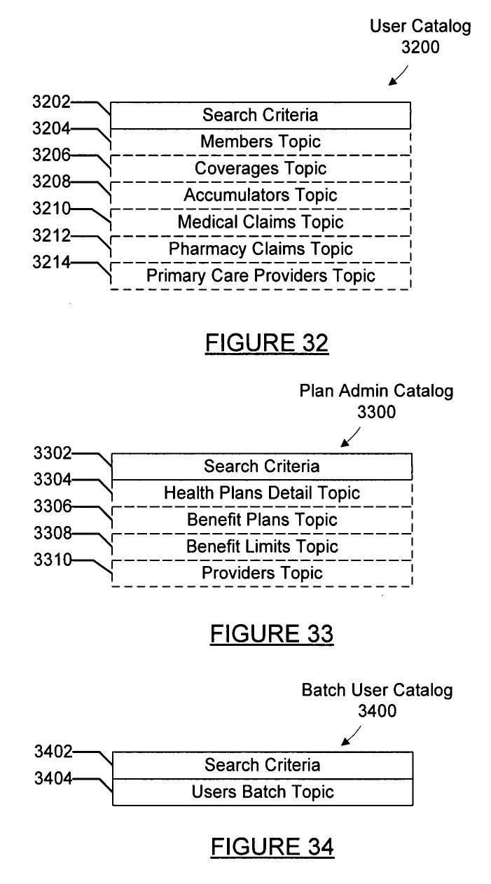

FIG. 30 shows a users with updates topic (3000) in accordance with one or more embodiments of the invention. A users with updates topic (3000) represents a list of user identifiers of users that have updates in topics included in a user catalog. A user catalog is explained in reference to FIG. 32 below. The users with updates topic (3000) is used when updates from a health plan provider to a health care data repository of a health care data access service are performed. In one or more embodiments of the invention, when the update process is initiated by the health care data access service, the users with updates topic (3000) is returned as the result of a get request for the topic. Further, when the update process is initiated by the health plan provider, the users with updates topic (3000) is sent to the health care data access service in a set request. In some embodiments of the invention, multiple users with updates topics (3000) may be returned in response to the get request for the topic or sent with the set request. More specifically, if the number of user identifiers to be returned exceeds some predetermined number (e.g., 100), multiple messages are sent to the health care data access service, each including a users with updates topic (3000) that contains up to the predetermined number of user identifiers. The number of response messages required depends on the number of user identifiers.

A users with updates topic (3000) includes one or more user identifications (3002, 3004, 3006). A user identification (3002, 3004, 3006) may be a user name, sign-on name, an identifier that was selected or assigned via an authorization process with a health plan provider or any other suitable identifier that uniquely identifies a user.

FIG. 31 shows a user catalog request batch topic (3100) in accordance with one or more embodiments of the invention. A user catalog request batch topic (3100) represents user credentials and a query date range for a list of user identifiers that have updates in topics associated with a user catalog. A user catalog is explained in reference to FIG. 32 below. In one or more embodiments of the invention, the user catalog request batch topic (3100) is used when updates from a health plan provider to a health care data repository of a health care data access service are performed. More specifically, after a health care data access service receives a users with updates topic (described above in reference to FIG. 30) from a health plan provider, the health care data access service sends a user catalog request batch topic (3100) in a set request to the health plan provider to initiate the transfer of updated data corresponding to one or more of the users identified in the received users with updates topic. The content of the user catalog request batch topic (3100) is based on the content of the received users with updates topic (3000).

A user catalog request batch topic (3100) includes one or more user catalog search criteria (3102, 3104, 3106). User catalog search criteria (3102, 3104, 3106) include the elements required to authenticate a user and request user catalog data from a health plan provider. These elements may include the payer identification, user credentials, and date search criteria. The payer identification includes a payer identifier that uniquely identifies a payer organization of the health plan provider. The user credentials include the elements required to authenticate the user with the payer organization. These elements may include user identification and the user's password. The user identification may be a user name, sign-on name, an identifier selected or assigned via an authorization process with the health plan, or any other suitable type of identification. The date search criteria include the date range (i.e., start date/time and end date/time) for which the user catalog data is requested.

FIG. 32 shows a user catalog (3200) in accordance with one or more embodiments of the invention. A user catalog (3200) represents a collection of topics for a single user. A user catalog may include search criteria (3202), a members topic (3204), a coverages topic (3206), an accumulators topic (3208), a medical claims topic (3210), a pharmacy claims topic (3212), and a primary care providers topic (3214). The search criteria (3202) include the search criteria used to locate the data included in the topics (3204-3214). The formats of the topics (3204-3214) are described in more detail above in relation to FIGS. 4, 12, 14, 20, 23, and 16. Each of these topics (3204-3214) may include information as described above for the user and for each of the user's dependents who are members of one or more of the user's health care plans. For example, the medical claims topic (3210) may include medical claims for the user and the user's dependents.

FIG. 33 shows a plan admin catalog (3300) in accordance with one or more embodiments of the invention. A plan admin catalog (3300) represents a collection of topics that are managed by health plan provider administrators. More specifically, the plan admin catalog (3300) includes administrative topics that represent information from a health plan provider that is common to multiple members of the health plan. In one or more embodiments of the invention, the plan admin catalog (3100) is used to periodically update the administrative data of a health plan provider in a health care data repository of a health care data access service. In one or more embodiments of the invention, a health plan data access service sends a get request for the plan admin catalog (3300) to a health plan provider to request updates to one or more administrative topics (i.e., topics 3304-3310). The get request for a plan admin catalog (3300) may include search criteria specific to a plan admin catalog. These search criteria may include payer identification and date search criteria. The payer identification includes a payer identifier that uniquely identifies a payer organization of the health plan provider. The date search criteria include the date range (i.e., start date/time and end date/time) for which the plan admin catalog data is requested. Further, in one or more embodiments of the invention, a health plan provider sends administrative data updates to a health plan data access service in a set request that includes a plan admin catalog (3300).

A plan admin catalog (3300) may include search criteria (3302), a health plans detail topic (3304), a benefit plans topic (3306), a benefit limits topic (3308), and a providers topic (3310). The search criteria (3302) include the search criteria used to locate the data included in the topics (3304-3310). The formats of the topics (3304-3310) are described in more detail above. Each of these topics (3304-3310) may include information for the health plan provider as described above in relation to FIGS. 6, 8, 10, and 18. For example, the providers topic (3310) may include information about service providers in the network of the health plan provider.

FIG. 34 shows a batch user catalog (3400) in accordance with one or more embodiments of the invention. A batch user catalog (3400) represents a batch of data corresponding to multiple users. More specifically, a batch user catalog (3400) represents a user batch topic (2400) for each user. In one or more embodiments of the invention, the batch user catalog (3400) is used when updates from a health plan provider to a health care data repository of a health care data access service are performed. More specifically, after a health care data access service sends a user catalog request batch topic (described above in reference to FIG. 31) to a health plan provider, the health plan provider sends a batch user catalog (3400) in a set request to the health care data access service to transfer updated data for the users identified in the received user catalog request batch topic.

A batch user catalog (3400) may include search criteria (3402) and a users batch topic (3404). The search criteria (3402) include the search criteria used to locate the data included in the users batch topic (3404). The format of the users batch topic (3404) is described in more detail above in reference to FIG. 25. Each of the user batch topics included in the users batch topic (3404) may include information for a user batch topic as described above in reference to FIG. 24.

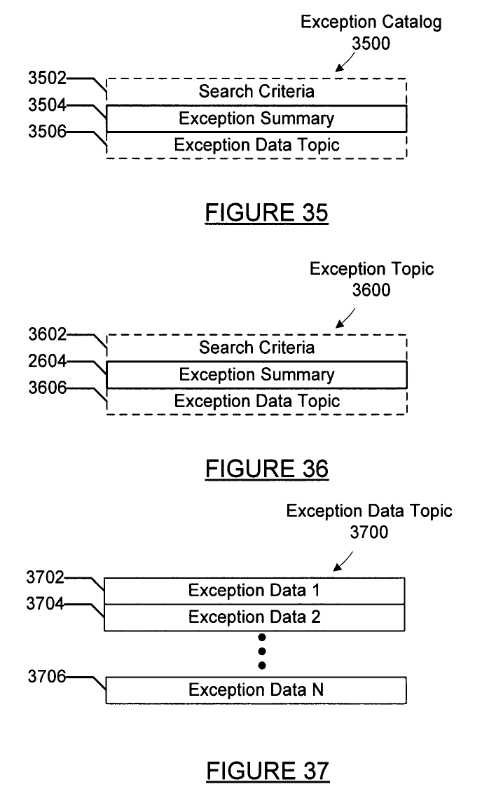

FIG. 35 shows an exception catalog (3500) in accordance with one or more embodiments of the invention. An exception catalog (3500) includes information about one or more exceptions that occurred during the processing of a get request or a set request related to a catalog. An exception catalog may be returned in a response message corresponding to a get request along with or in place of the requested catalog. For example, if a get request is used to request user catalog data for one thousand users and the user credentials presented for ten of those users are invalid, the response message corresponding to the get request includes the user catalog data for those users having valid user credentials and an exception catalog containing an exception related to invalid user credentials for each of the ten users having invalid credentials.

An exception catalog (3500) may include search criteria (3502), an exception summary (3504), and an exception data topic (3506). The search criteria (3502) include the search criteria used in a get request that resulted in the exception(s). The exception summary (3504) includes summary information about the exceptions. This summary information may include a code that identifies the type of exception and an identifier of the catalog that was being accessed when the exception occurred. The exception data topic (3506) includes additional data regarding the exception. The format of an exception data topic is explained below in reference to FIG. 37.

FIG. 36 shows an exception topic (3600) in accordance with one or more embodiments of the invention. An exception topic (3600) includes information about an exception that occurred during the processing of a get request or a set request related to a topic. An exception topic may be returned in a response message corresponding to a get request along with or in place of the requested topic. In addition, an exception topic may be returned in a response message corresponding to a set request if an exception occurred during processing of the set request.

An exception topic (3600) may include search criteria (3602), an exception summary (3604), and an exception data topic (3606). The search criteria (3602) include the search criteria included in a get request resulting in the exception. The exception summary (3604) includes summary information about an exception. This summary information may include a code that identifies the type of exception and an identifier of the topic that was being accessed when the exception occurred. The exception data topic (3606) includes additional data regarding the exception. The format of an exception data topic is explained below in reference to FIG. 37.

FIG. 37 shows an exception data topic (3700) in accordance with one or more embodiments of the invention. An exception data topic (3700) includes one or more exception data details (3702, 3704, 3706) about one or more exceptions. Each exception data details (3702, 3704, 3706) may include an exception topic identifier that identifies an exception topic and the data corresponding to the exception topic.

FIG. 38 shows an acknowledge topic (3800) in accordance with one or more embodiments of the invention. An acknowledge topic (3800) represents an acknowledgement response for set request messages. An acknowledge topic (3800) may include an acknowledgement (3802). An acknowledgement (3802) may be any suitable value that indicates to the requester that a set request message was received and whether or not the set request was successfully completed. For example, in some embodiments of the invention, an acknowledgement value of 1 indicates that the set request was successfully completed and any other value is an error code.

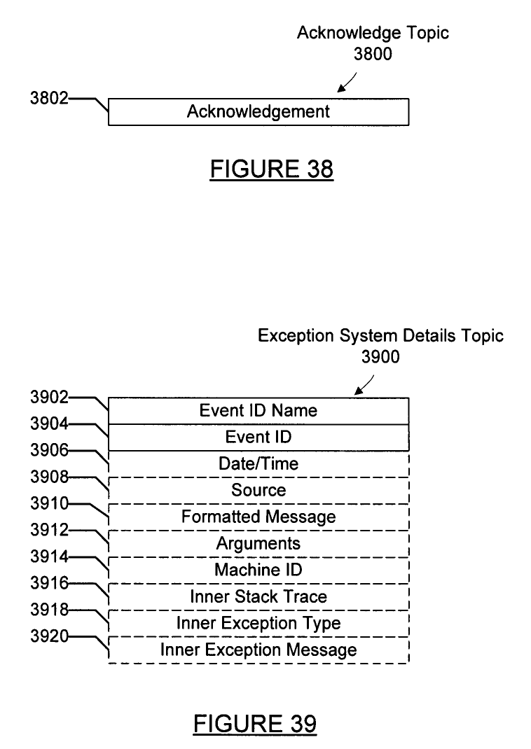

FIG. 39 shows an exception system details topic (3900) in accordance with one or more embodiments of the invention. An exception system details topic (3900) includes system level details about an exception. This topic includes information needed for logging, monitoring, or debugging purposes. An exception system details topic (3900) may include an event ID name (3902), an event ID (3904), a Date/Time (3906), a source (3908), a formatted message (3910), arguments (3912), a machine ID (3914), an inner stack trace (3916), an inner exception type (3918), and an inner exception message (3920). An event ID name (3902) is a textual name of the event (e.g., Authenticate_InvalidUser). An event ID (3904) is an enumerated code for the event. The Date/Time (3906) is the date and time of the exception. The source (3908) identifies the location (i.e., code module) where the event was detected. The formatted message (3910) is a human readable message describing the remainder of the entries in the exception details topic (3900). The arguments (3912) are specific data that goes into the formatted message (3910). The machine ID (3914) identifies the physical machine where the exception occurred. The inner stack trace (3916) is the stack trace of the implementation language. The inner exception type (3918) is the exception type thrown by the implementation language. The inner exception message (3920) is the message associated with the implementation language exception.

As previously explained, in one or more embodiments of the invention, the HCDT protocol may be implemented by HCDT web services configured to perform the communication. In such embodiments, the service interfaces of HCDT web services (i.e., the message formats and protocol bindings of the HCDT protocol) may be defined using the Web Services Description Language (WSDL). The WSDL description provides an overview of the HCDT web service, including the supported operations and messages of the HCDT web service and where the HCDT web service is located. Further, the health care topics and health care catalogs of the health care domain corresponding to the HCDT web service may be defined as Extensible Markup Language (XML) schema in one or more XML Schema Definition (XSD) files.

The WSDL description may be stored with the HCDT web service on the host server (e.g., a health care data access service, an HCDT server, etc.) or may be registered in a web service registry. A client of the HCDT web service may invoke the HCDT web service as defined by the WSDL description by calling functions defined in the HCDT WSDL file using SOAP messages. For example, in some embodiments of the invention, a consumer health care application may use SOAP to call functions defined in the HCDT WSDL file describing the web service application on the health care data access service. Similarly, the health care data access service may use SOAP to call functions defined in the WSDL files describing the HCDT web services on HCDT servers and vice versa.

Each of the HCDT web services exposes four methods that implement the four actions of the HCDT protocol: a set topic data method, a get topic data method, a set catalog data method, and a get catalog data method. Referring to FIG. 2, in each HCDT request message (200), the action identifier (204) identifies the method to invoke and the parameters (206) are the parameters of the method. The action result (208) of the corresponding HCDT response message is the result of executing the identified method.

FIGS. 40A-40D show the formats of the HCDT request/response messages as implemented in a HCDT web service in accordance with one or more embodiments of the invention. As shown in FIG. 40A, a get topic data request message (4000) includes an identifier corresponding to a get topic data method (4002), a topic identifier (4004), and optional topic search criteria (4006). The topic search criteria (4006), if present, are used to further specify what portions of the data corresponding to the topic are requested. A get topic data response message (4008) includes the requested topic data (4010). The requested topic data is returned in a data structure corresponding to the topic identified in the get topic data request message (4000).

As shown in FIG. 40B, a set topic data request message (4012) includes an identifier corresponding to a set topic data method (4014), a topic identifier (4016), and topic data (4018). The topic data (4018) is a data structure corresponding to the topic identified by the topic identifier (4016) containing the health care data represented by the topic. A set topic data response message (4020) includes a set topic result (4022) that may be either an acknowledgment that the set request was completed successfully or an HCDT exception.

As shown in FIG. 40C, a get catalog data request message (4024) includes an identifier corresponding to a get catalog data method (4026), a catalog identifier (4028), and optional catalog search criteria (4030). The catalog search criteria (4030), if present, are used to further specify what portions of the data corresponding to the catalog are requested. A get catalog data response message (4032) includes the requested catalog data (4034). The requested catalog data is returned in a data structure corresponding to the catalog identified in the get catalog data request message (4000).

As shown in FIG. 40D, a set catalog data request message (4036) includes an identifier corresponding to a set catalog data method (4040), a catalog identifier (4030), and catalog data (4042). The catalog data (4042) is a data structure corresponding to the catalog identified by the catalog identifier (4040) containing the health care data represented by the catalog. A set catalog data response message (4044) includes a set catalog result (4046) that may be either an acknowledgment that the set request was completed successfully or an HCDT exception.

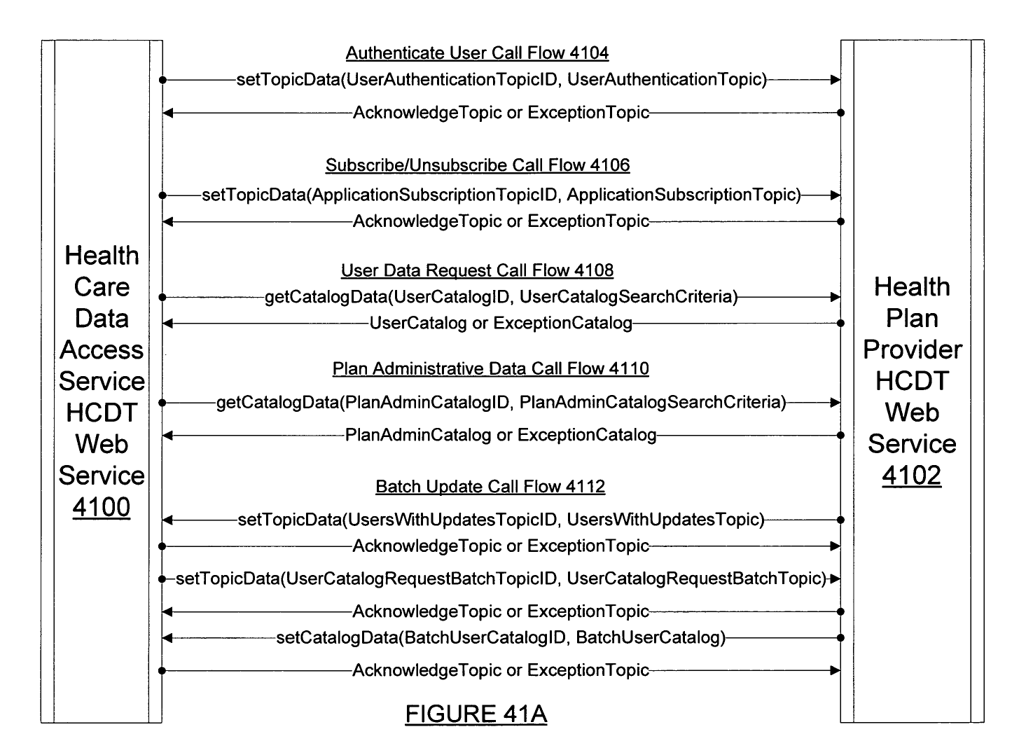

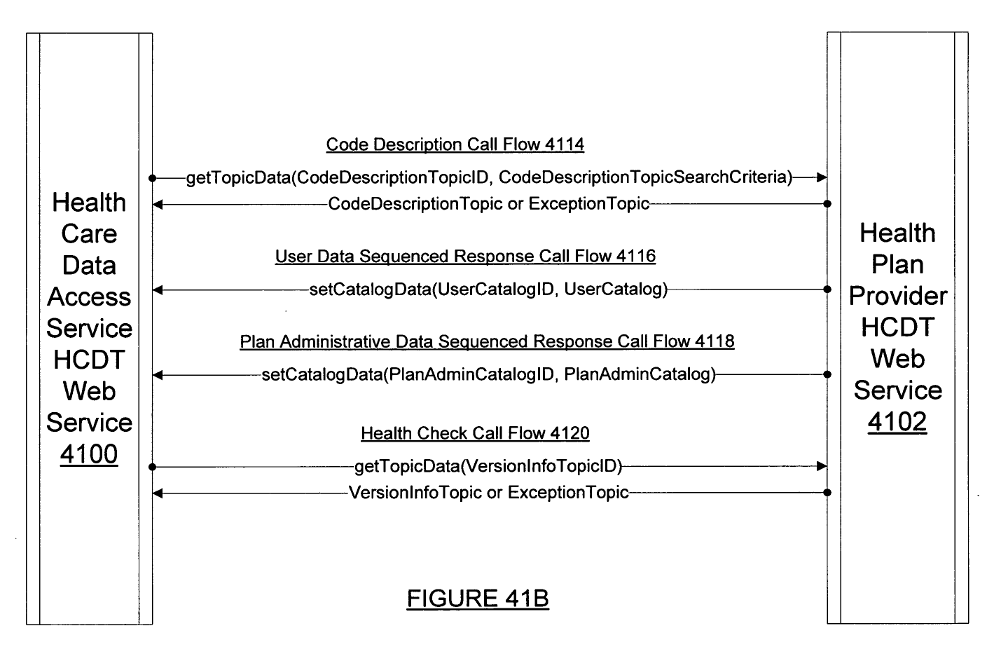

FIGS. 41A and 41B show call flows for the transfer of health care data in accordance with one or more embodiments of the invention. More specifically, FIGS. 41A and 41B illustrate the flow of request/response messages between an HCDT web service operating on a health care data access service (e.g., Health Care Data Access Service HCDT Web Service (4100)) and an HCDT web service interfacing with a health plan provider (e.g., Health Plan Provider HCDT web service (4102)) in one or more embodiments of the invention. In some embodiments of the invention, the health plan provider HCDT web service (e.g., Health Plan Provider HCDT web service (4102)) may be executing on an HCDT server if the health plan provider does not support the HCDT protocol.

In the illustrated call flows, getTopicData is a get topic data method (4002), setTopicData is a set topic data method (4014), getCatalogData is a get catalog data method (4026), and setCatalogData is a set catalog data method (4038), as described above in reference to FIGS. 40A-40B. Further, the topics and catalogs shown in these call flows are the topics and catalogs defined in the HCDT protocol for a health plan business domain, as described in reference to FIGS. 3-39.

FIG. 41A illustrates an authenticate user call flow (4104), a subscribe/unsubscribe user call flow (4106), a user data request call flow (4108), a plan administrative data call flow (4110), and a batch update call flow (4112). In an authenticate user call flow (4104), the health care data access service HCDT web service (4100) sends a set topic data request message to the health plan provider HCDT web service (4102) to authenticate a user. The set topic data request message includes an identifier corresponding to the setTopicData method and parameters for the setTopicData method. These parameters are a topic identifier for the user authentication topic (i.e., UserAuthenticationTopicID), and the user authentication topic data (i.e., UserAuthenticationTopic).

The health plan provider HCDT web service (4102) invokes the setTopicData method with the specified parameters to authenticate the user using the user authentication topic data and returns a set topic data response message to the health care data access service HCDT web service (4100) reporting the outcome of executing the setTopicData method. The set topic data response message includes either an acknowledge topic (i.e., AcknowledgeTopic) if the authentication is successful or an exception topic (i.e., ExceptionTopic) if the authentication is not successful.

In a subscribe/unsubscribe call flow (4106), the health care data access service HCDT web service (4100) sends a set topic data request message to the health plan provider HCDT web service (4102) to update a user's subscription status. The set topic data request message includes an identifier corresponding to the setTopicData method and parameters for the setTopicData method. These parameters are a topic identifier for the application subscription topic (i.e., ApplicationSubscriptionTopicID), and the application subscription topic data (i.e., ApplicationSubscriptionTopic).

The health plan provider HCDT web service (4102) invokes the setTopicData method with the specified parameters to update the user's subscription status based on the application subscription topic data and returns a set topic data response message to the health care data access service HCDT web service (4100) reporting the outcome of executing the setTopicData method. The set topic data response message includes either an acknowledge topic (i.e., AcknowledgeTopic) if the update is successful or an exception topic (i.e., ExceptionTopic) if the update is not successful.

In a user data request call flow (4108), the health care data access service HCDT web service (4100) sends a get catalog data request message to the health plan provider HCDT web service (4102) to request all or some portion of a user's health care data. The get catalog data request message includes an identifier corresponding to the getCatalogData method and parameters for the getCatalogData method. These parameters are a catalog identifier for the user catalog (i.e., UserCatalogID), and optional search criteria (i.e., UserCatalogSearchCriteria). If present, the search criteria specify what portion of the user's health care data is requested. If the search criteria are not included, the request is for all of the user's health care data specified by the user catalog.

The health plan provider HCDT web service (4102) invokes the getCatalogData method with the specified parameters to retrieve the user's health care data and returns a get catalog data response message to the health care data access service HCDT web service (4100). The get catalog data response message includes a user catalog (i.e., UserCatalog) containing the user's health care data if the request is successfully completed or an exception catalog (i.e., ExceptionCatalog) if the request is not successfully completed.

In a plan administrative data call flow (4110), the health care data access service HCDT web service (4100) sends a get catalog data request message to the health plan provider HCDT web service (4102) to request all or some portion of the administrative data of the health plan provider. The get catalog data request message includes an identifier corresponding to the getCatalogData method and parameters for the getCatalogData method. These parameters are a catalog identifier for the plan admin catalog (i.e., PlanAdminCatalogID), and optional search criteria (i.e., PlanAdminCatalogSearchCriteria). If present, the search criteria specify what portion of the health plan provider's administrative data is requested. If the search criteria are not included, the request is for all of the health plan provider's administrative data specified by the plan admin catalog.

The health plan provider HCDT web service (4102) invokes the getCatalogData method with the specified parameters to retrieve the health plan provider's administrative data and returns a get catalog data response message to the health care data access service HCDT web service (4100). The get catalog data response message includes a plan admin catalog (i.e., PlanAdminCatalog) containing the health plan provider's administrative data if the request is successfully completed or an exception catalog (i.e., ExceptionCatalog) if the request is not successfully completed.

In a batch update call flow (4112), the health plan provider HCDT web service (4102) sends a set topic data request message to the health care data access service HCDT web service (4100) to inform the health care data access service that updated health care data is available for users of the health care data access service. The set topic data request message includes an identifier corresponding to the setTopicData method and parameters for the setTopicData method. These parameters are a topic identifier for the users with updates topic (i.e., UsersWithUpdatesTopicID), and the users with updates topic data (i.e., UsersWithUpdatesTopic).

The health care data access service HCDT web service (4100) invokes the setTopicData method with the specified parameters to inform the health care data access service that updates are available from the health plan provider for the users identified in the users with updates topic data. The health care data access service HCDT web service (4100) also returns a set topic data response message to the health plan provider HCDT web service (4102) reporting the outcome of executing the setTopicData method. The set topic data response message includes either an acknowledge topic (i.e., AcknowledgeTopic) if the set request is successfully completed or an exception topic (i.e., ExceptionTopic) if the set request is not successfully completed.

If the set request is successful, the health care data access service HCDT web service (4100) sends a set topic data request message to the health plan provider HCDT web service (4102) to request the updated health care data for the users identified in the users with updates topic data. The set topic data request message includes an identifier corresponding to the setTopicData method and parameters for the setTopicData method. These parameters are a topic identifier for the user catalog request batch topic (i.e., UserCatalogRequestBatchTopicID), and the user catalog request batch topic data (i.e., UserCatalogRequestBatchTopic).

The health plan provider HCDT web service (4102) invokes the setTopicData method with the specified parameters to authenticate each of the users and to initiate the transfer of the users' updated health care data based on the user catalog request batch topic data. The health plan provider HCDT web service (4102) also returns a set topic data response message to the health care data access service HCDT web service (4100) reporting the outcome of executing the setTopicData method. The set topic data response message includes either an acknowledge topic (i.e., AcknowledgeTopic) if the authentication and initiation are successfully completed or an exception topic (i.e., ExceptionTopic) if the authentication and initiation are not successfully completed.

If the authentication and initiation are successfully completed, the health plan provider HCDT web service (4102) sends a set catalog data request message to the health care data access service HCDT web service (4100) with the users' updated health care data. The set catalog data request message includes an identifier corresponding to the setCatalogData method and parameters for the setCatalogData method. These parameters are a topic identifier for the batch user catalog (i.e., BatchUserCatalogID), and the batch user catalog data (i.e., BatchUserCatalog).

The health care data access service HCDT web service (4100) invokes the setCatalogData method with the specified parameters to update the users' health care data. The health care data access service HCDT web service (4100) also returns a set topic data response message to the health plan provider HCDT web service (4102) reporting the outcome of executing the setCatalogData method. The set catalog data response message includes either an acknowledge topic (i.e., AcknowledgeTopic) if the update is successful or an exception topic (i.e., ExceptionTopic) if the update is not successful.

FIG. 41B illustrates a code description call flow (4114), a user data sequenced response call flow (4116), a plan administrative data sequenced response call flow (4118), and a health check call flow (4120). In a code description call flow (4114), the health care data access service HCDT web service (4100) sends a get topic data request message to the health plan provider HCDT web service (4102) to request code description data. The get topic data request message includes an identifier corresponding to the getTopicData method and parameters for the getTopicData method. These parameters are a topic identifier for the code description topic (i.e., CodeDescriptionTopicID), and optional search criteria (i.e., CodeDescriptionTopicSearchCriteria

The health plan provider HCDT web service (4102) invokes the getTopicData method with the specified parameters to retrieve the code description data and returns a get topic data response message to the health care data access service HCDT web service (4100). The get topic data response message includes a code description topic (i.e., CodeDescriptionTopic) containing the code description data if the request is successfully completed or an exception catalog (i.e., ExceptionCatalog) if the request is not successfully completed

The user data sequenced response call flow (4116) illustrates the call flow when a get catalog data request message for a user catalog as described above in reference to the first use call flow (4108) results in the transfer of a large volume of health care data from a health plan provider to a health care data access service. Rather than transfer the large volume of health care data in a single get catalog data response message, the health care data is sent as a series of smaller data transfers. The first data transfer in the series is the user catalog returned in the get catalog data response message. The remainder of the data transfers are in accordance with the user data sequenced response call flow (4116).

In a user data sequenced response call flow (4116), the health plan provider HCDT web service (4102) sends a set catalog data request message to the health care data access service HCDT web service (4100). The set catalog data request message includes an identifier corresponding to the setCatalogData method and parameters for the setCatalogData method. These parameters are a catalog identifier for the user catalog (i.e., UserCatalogID), and a user catalog (i.e., UserCatalog) containing a portion of the health care data being returned in response to the get catalog data request message for a user catalog. The health care data access service HCDT web service (4100) invokes the setCatalogData method with the specified parameters to update the user's health care data based on the content of the user catalog.

The plan administrative data sequenced response call flow (4118) illustrates the call flow when a get catalog data request message for a plan admin catalog as described above in reference to the plan administrative data call flow (4110) results in the transfer of a large volume of administrative data from a health plan provider to a health care data access service. Rather than transfer the large volume of administrative data in a single get catalog data response message, the administrative data is sent as a series of smaller data transfers. The first data transfer in the series is the plan admin catalog returned in the get catalog data response message. The remainder of the data transfers is in accordance with the plan administrative data sequenced response call flow (4118).

In a plan administrative data sequenced response call flow (4118), the health plan provider HCDT web service (4102) sends a set catalog data request message to the health care data access service HCDT web service (4100). The set catalog data request message includes an identifier corresponding to the setCatalogData method and parameters for the setCatalogData method. These parameters are a catalog identifier for the plan admin catalog (i.e., UserCatalogID), and a plan admin catalog (i.e., PlanAdminCatalog) containing a portion of the administrative data being returned in response to the get catalog data request message for a plan admin catalog. The health care data access service HCDT web service (4100) invokes the setCatalogData method with the specified parameters to update the health plan provider's administrative data based on the content of the plan admin catalog.

In a health check call flow (4120), the health care data access service HCDT web service (4100) sends a get topic data request message to the health plan provider HCDT web service (4102) to request version information. The get topic data request message includes an identifier corresponding to the getTopicData method and a parameter for the getTopicData method. The parameter is a topic identifier for the version info topic (i.e., VersionInfoTopicID).

The health plan provider HCDT web service (4102) invokes the getTopicData method with the specified parameters to retrieve the version information and returns a get topic data response message to the health care data access service HCDT web service (4100). The get topic data response message includes a version info topic (i.e., VersionInfoTopic) containing the version information if the request is successfully completed or an exception topic (i.e., ExceptionTopic) if the request is not successfully completed.

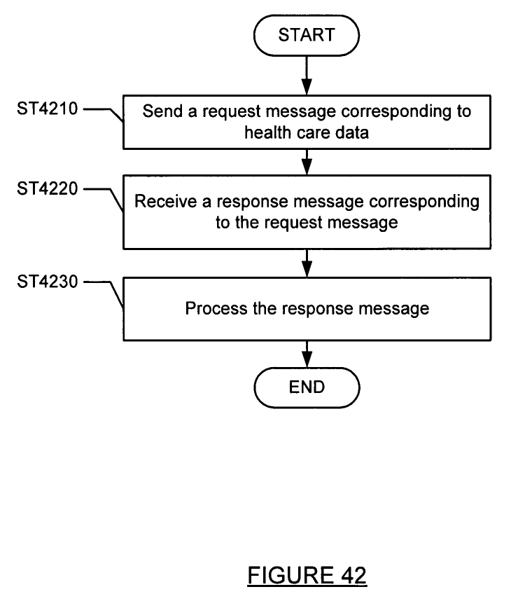

FIGS. 42-44 show flowcharts of methods for the exchange of health care data in accordance with one or more embodiments of the invention. While the various steps in these flowcharts are presented and described sequentially, one of ordinary skill will appreciate that some or all of the steps may be executed in different orders and some or all of the steps may be executed in parallel.

FIG. 42 shows a flowchart of a method for requesting an action corresponding to health care data in accordance with one or more embodiments of the invention. In some embodiments of the invention, the message transfer described below may adhere to an HCDT protocol. Initially, a request message corresponding to health care data is sent from one entity in a health care data transfer system to another entity in the health care data transfer system (ST4210). The health care data may be represented in the parameter of the request message as a topic or a catalog in a health care business domain. The request message may be a get request message requesting health care data corresponding to a topic or a catalog or a set request message requesting modifications to health care data corresponding to a topic or catalog. If the request message is a get request message, the parameters of the message may also include search criteria that further define the health care data to be returned. For example, the search criteria may be a date range that specifies that only topic data created or updated within that date range be returned. If the request message is a set request message, the request message also includes the modifications in a data structure corresponding to the topic or catalog.

In one or more embodiments of the invention, the entity sending the request message may be a health care data access service and the entity receiving the request message may be a health care information source (and vice-versa). In some embodiments of the invention, the entity sending the request message may be a consumer health care application and the entity receiving the request message may be a health care information source and/or a health care data access service (and vice-versa). In addition, in some embodiments of the invention, an HCDT server may be associated with a health care information source and may send or receive the request message for the health care information source. Further, in one or more embodiments of the invention, the request message may be directed to a web service on the entity receiving the request message.

After the request message is processed by the receiving entity, a response message corresponding to the request message is received by the entity sending the request message (ST4220). If the request message was a get request message, the response message includes the requested health care data. More specifically, the response message includes the requested health care data in a data structure corresponding the requested topic or catalog. If the request message was a set request message, the response message may include either an acknowledgement of the request, indicating that the set request was successfully completed or an exception indicating that the set request was unsuccessful.

The entity that originally sent the request message then processes the response message (ST4230). If the request message was a get request message, processing the response message may include storing the health care data in the response message in a health care data repository if the requesting entity was a health care data access service or a consumer health care application. If the requesting entity was a health care information source, processing the response message may include storing the health care data in one or more databases maintained by the health care information source. If the requesting entity was an HCDT server, processing the response message may include translating the response message into one or more messages in a format understood by the health care information source associated with the HCDT server.

If the request message was a set request message, processing the response message may include logging the acknowledgement or the exception included in the response message, requesting additional information regarding an exception from the entity that received the request message, and/or notifying a user of the acknowledgement or exception. Further, if the requesting entity was an HCDT server, processing the response message may include translating the response message into one or more messages in a format understood by the health care information source associated with the HCDT server.

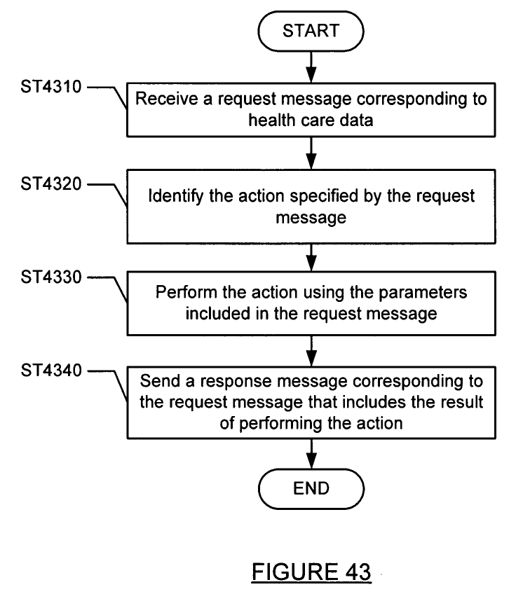

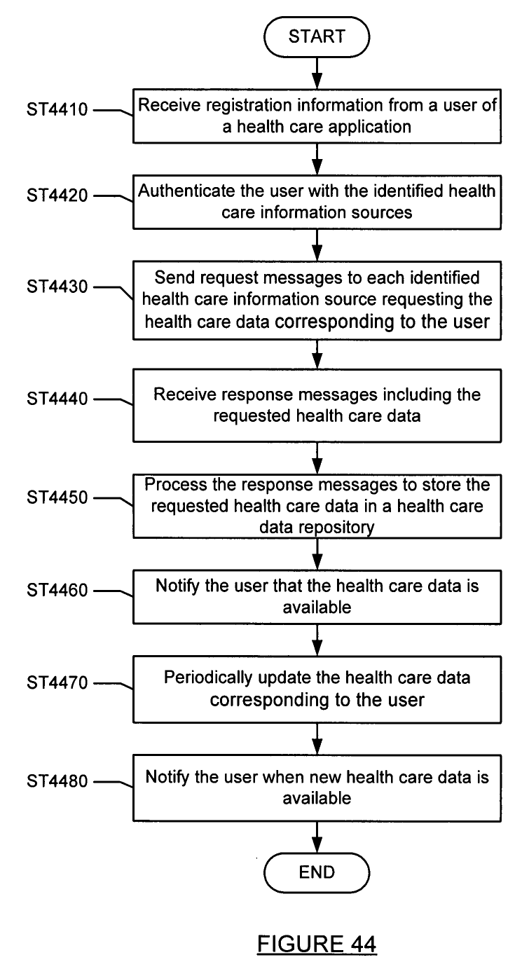

FIG. 43 shows a flowchart of a method for responding to a request for an action corresponding to health care data in accordance with one or more embodiments of the invention. In some embodiments of the invention, the message exchange described below may adhere to an HCDT protocol. Initially, a request message corresponding to health care data is received by an entity in a health care data transfer system from another entity of the health care data transfer system (ST4310). The health care data may be represented in the parameters of the request message as a topic or catalog in a health care business domain. The request message may be a get request message requesting health care data corresponding to a topic or a catalog or a set request message requesting modifications to health care data corresponding to a topic or catalog. If the request message is a get request message, the parameters of the message may also include search criteria that further define the health care data to be returned. For example, the search criteria may be a date range that specifies that only topic data created or updated within that date range be returned. If the request message is a set request message, the request message also includes the modifications in a data structure corresponding to the topic or catalog.

In one or more embodiments of the invention, the entity receiving the request message may be a health care data access service and the entity sending the request message may be a health care information source (and vice-versa). In some embodiments of the invention, the entity receiving the request message may be a consumer health care application and the entity sending the request message may be a health care information source and/or a health care data access service (and vice-versa). In addition, in some embodiments of the invention, an HCDT server may be associated with a health care information source and may send or receive the request message for the health care information source. Further, in one or more embodiments of the invention, the request message may be directed to a web service on the entity receiving the request message.

After receiving the request message, the action specified by the request message is identified (ST4320) and the action is performed by the receiving entity using the parameters, if any, included in the request message (ST4330). If the request message is a get request message, the identified action is to fetch the requested health care data corresponding to the topic or catalog identified in the parameters and the search criteria, if any. Performing the action includes locating the requested health care data and generating a response message including the requested data in a data structure corresponding to the topic or catalog.

If the receiving entity is a health care data access service or a consumer health care application, locating the requested data includes accessing the data in a health care data repository. If the receiving entity is a health care information source, locating the requested data includes accessing the data in one or more databases maintained by the health care information source. If the receiving entity is an HCDT server, locating the requested data includes translating the action into one or more messages in a format understood by the health care information source associated with the HCDT server, sending the messages to the health care information source to access the requested data, and receiving responses to the messages that include the requested data.

If the request message is a set request message, the identified action is to modify health care data stored by the receiving entity in accordance with the contents of the topic or catalog data structure included in the request message. Performing the action includes making the requested modifications and generating a response message including an acknowledgement to indicate the success performing the action or an exception to indicate the action was not successfully completed.

If the receiving entity is a health care data access service or a consumer health care application, making the requested modifications includes storing the data corresponding to the modifications in a health care data repository. If the receiving entity is a health care information source, making the requested modifications includes storing the data corresponding to the modifications in one or more databases maintained by the health care information source. If the receiving entity is an HCDT server, making the requested modifications includes translating the action into one or more messages in a format understood by the health care information source associated with the HCDT server, sending the messages to the health care information source to make the requested modifications, and receiving responses to the messages that indicate whether the modifications were successfully completed.

Once the response message corresponding to the request message is generated, the response message is sent to the requesting entity (ST4340). As explained above, the response message includes the result of performing the requested action (e.g., a data structure corresponding to a topic or catalog, an acknowledgement or an exception).

FIG. 44 shows a flowchart of a method for maintaining health care data by a health care data access service in accordance with one or more embodiments of the invention. Initially, registration information from a user of a consumer health care application is received by the health care data access service (ST4410). The registration information may include identification of the health care information sources that maintain health care data corresponding to the user and the user's authentication information (e.g., user id and password) for each of the identified health care information sources.

The health care data access service then requests the health care data corresponding to the user from each of the identified health care information sources. The request process includes authenticating the user with each of the identified health care information sources using the authentication information supplied by the user (ST4420) and sending request messages to each identified health care information source requesting the health care data corresponding to the user (ST4430).

The health care data access service then receives response messages corresponding to the request messages that include the requested health care data from each health care information source (ST4440). Upon receipt, the health care data access service processes the response message to store the health care data in a health care data repository (ST4450).

After response messages from each health care data source are received and processed, the health care data access service notifies the user that the health care data is now available in the health care data repository (ST4460). The user may then access the data using the consumer health care application.

After the initial download of the health care data from the identified health care information sources, the health care data corresponding to the user is periodically updated from each of the user's health care information sources (ST4470). In one or more embodiments of the invention, either the health care data access service or a health care information source may initiate a periodic update. When new health care data is downloaded for the user as the result of a periodic update, the health care data access service notifies the user that new health care data is available in the health care data repository (ST4480).

Those skilled in the art will appreciate that in one or more embodiments, the invention provides the ability for a consumer to access health care data from multiple health care information sources from a single consumer health care application. Further, embodiments of the invention provide a standard protocol for requesting and modifying health care data in different health care business domains. This protocol may be used for communication of health care data between health care information sources corresponding to the health care business domain and a consumer health care application and/or a health care data access service. In some embodiments of the invention, this protocol may also be used for communication of health care data between a consumer health care application and a health care data access service.

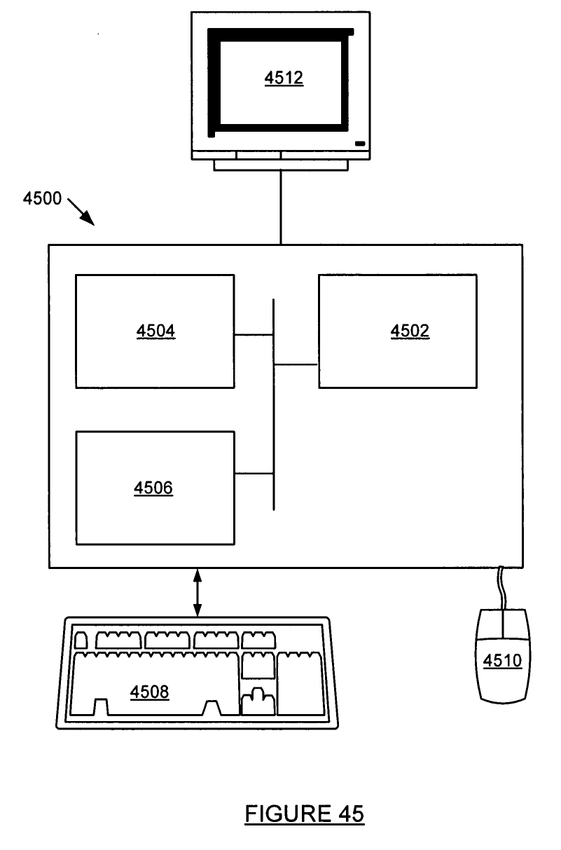

Embodiments of the invention may be implemented on virtually any type of computer regardless of the platform being used. For example, as shown in FIG. 45, a computer system (4500) includes a processor (4502), associated memory (4504), a storage device (4506), and numerous other elements and functionalities typical of today's computers (not shown). The computer (4500) may also include input means, such as a keyboard (4508) and a mouse (4510), and output means, such as a monitor (4512). The computer system (4500) may be connected to a local area network (LAN) or a wide area network (e.g., the Internet) (not shown) via a network interface connection (not shown). Further, the computer system (4500) may be a mobile device connected to a wireless connection. Those skilled in the art will appreciate that these input and output means may take other forms.

Further, those skilled in the art will appreciate that one or more elements of the aforementioned computer system (4500) may be located at a remote location and connected to the other elements over a network. Further, embodiments of the invention may be implemented on a distributed system having a plurality of nodes, where each portion of the invention may be located on a different node within the distributed system. In one or more embodiments of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for transferring health care data between a consumer health care application and a plurality of health care information sources, the method comprising:
requesting a first portion of health care data corresponding to a consumer from a first health care information source of the plurality of health care information sources;
receiving the first portion of health care data from the first health care information source;
storing the first portion of health care data in a health care data repository;
requesting a second portion of health care data corresponding to the consumer from a second health care information source of the plurality of health care information sources;
receiving the second portion of health care data from the second health care information source;
storing the second portion of health care data in the health care data repository; and
accessing the first portion of health care data and the second portion of health care data from the health care data repository.

2. The method of claim 1, wherein accessing the first portion of health care data and the second portion of health care data is by the consumer health care application.

3. The method of claim 1, further comprising:
receiving, from the consumer health care application, first authentication information corresponding to the first health care information source; and
receiving, from the consumer health care application, second authentication information corresponding to the second health care information source.

4. The method of claim 1, further comprising:
notifying the consumer that the first portion of health care data and the second portion of health care data are in the health care data repository.

5. The method of claim 1, wherein the first health care information source is a first health plan provider and the second health care information source is a second health plan provider.

6. The method of claim 1, wherein the first health care information source corresponds to a first health care business domain and the second health care information source corresponds to a second health care business domain.

7. The method of claim 6, wherein the first health care business domain and the second health care business domain are each one selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

8. The method of claim 1, wherein the first portion of health care data and the second portion of health care data are each at least one selected from a group consisting of member data, medical claim data, pharmacy claim data, benefit limit data, coverage data, accumulator data, provider data, and primary care provider data.

9. The method of claim 1, further comprising:
sending a third portion of health care data corresponding to the consumer to the first health care information source, wherein the first health care information source stores the third portion of health care data.

10. The method of claim 1, wherein requesting the first portion of health care data further comprises sending a request message comprising an action identifier corresponding to a get data request and an identifier corresponding to the first portion of health care data, and wherein receiving the first portion of health care data further comprises receiving a response message corresponding to the request message, the response message comprising the first portion of health care data.

11. The method of claim 10, wherein the action identifier identifies a health care data transfer protocol method selected from a group consisting of get topic data, set topic data, get catalog data and set catalog data, and wherein the first portion of health care data is one selected from a group consisting of a topic and a catalog, wherein the topic and the catalog comprise data structures corresponding to health care data in a health care business domain of the first health care information source.

12. The method of claim 9, wherein sending the third portion of health care data further comprises:
sending a request message comprising an action identifier corresponding to a set data request, an identifier corresponding to the third portion of health care data, and the third portion of health care data; and
receiving a response message corresponding to the request message.

13. The method of claim 12, wherein the request message further comprises search criteria.

14. The method of claim 1, further comprising:
receiving a request for a fourth portion of health care data corresponding to the consumer from the first health care information source;
sending the fourth portion of health care data to the first health care information source; and
storing the fourth portion of health care data.

15. The method of claim 14, wherein storing the fourth portion of health care data is by the first health care information source.

16. The method of claim 1, wherein the consumer health care application comprises the health care data repository.

17. A method for transferring health care data between a consumer health care application and a health care information source, the method comprising:
sending a first request message comprising a first request for performing a first action corresponding to a first portion of health care data;
receiving a first response message corresponding to the first request message, wherein the first response message comprises a result of performing the first action; and
processing the first response message,
wherein the first request message and the first response message adhere to a health care data transfer protocol.

18. The method of claim 17, wherein the first action is one selected from a group consisting of get topic data, set topic data, get catalog data and set catalog data, and wherein the first portion of health care data is one selected from a group consisting of a topic and a catalog, wherein the topic and the catalog comprise data structures corresponding to health care data in a health care business domain of the health care information source.

19. The method of claim 17, further comprising:
receiving authentication information corresponding to the health care information source.

20. The method of claim 17, wherein the health care information source corresponds to a health care business domain selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

21. The method of claim 17, wherein the first portion of health care data is at least one selected from a group consisting of member data, medical claim data, pharmacy claim data, benefit limit data, coverage data, accumulator data, provider data, and primary care provider data.

22. The method of claim 17, wherein the first request message comprises a first action identifier identifying the first action as a get data request and an identifier corresponding to the first portion of health care data, and wherein the first response message comprises the first portion of health care data.

23. The method of claim 22, wherein processing the first response message further comprises storing the first portion of health care data in a health care data repository.

24. The method of claim 23, wherein the consumer health care application accesses the first portion of health care data from the health care data repository.

25. The method of claim 17, wherein the first request message further comprises search criteria.

26. The method of claim 17, wherein the first request message comprises an action identifier identifying the first action as a set data request, an identifier corresponding to the first portion of health care data, and the portion of health care data, and the first response message comprises one selected from a group consisting of an acknowledgement and an exception.

27. The method of claim 17, further comprising:
receiving a second request message comprising a request for performing a second action corresponding to a second portion of health care data;
performing the second action; and
generating a second response message corresponding to the second request message, wherein the second response message comprises a result of performing the second action,
wherein the second request message and the second response message adhere to the health care data transfer protocol.

28. The method of claim 27, wherein
the second request message comprises an action identifier identifying the second action as a get data request and an identifier corresponding to the second portion of health care data; and
the second response message comprises the second portion of health care data.

29. The method of claim 28, wherein performing the second action further comprises retrieving the second portion of health care data from a health care data repository.

30. The method of claim 27, wherein the second request message comprises an action identifier identifying the second action as a set data request, an identifier corresponding to the second portion of health care data, and the second portion of health care data, and wherein the second response message comprises one selected from a group consisting of an acknowledgement and an exception.

31. A health care data transfer system comprising:
a health care information source configured to store a portion of health care data corresponding to a consumer; and
a health care data access service operatively connected to the health care information source, wherein the health care data access service comprises functionality to:
send a request message comprising a request for performing an action corresponding to the portion of health care data to the health care information source,
receive a response message corresponding to the request message, wherein the response message comprises a result of performing the action, and
process the response message,
wherein the request message and the response message adhere to a health care data transfer protocol.

32. The health care data transfer system of claim 31, further comprising:
a health care data server operatively connected to the health care information source and the health care data access service, wherein the health care data server comprises functionality to:
receive the request message,
interact with the health care information source to perform the action, and
send the response message to the health care data access service.

33. The health care data transfer system of claim 31, wherein the action is one selected from a group consisting of get topic data, set topic data, get catalog data and set catalog data, and wherein the portion of health care data is one selected from a group consisting of a topic and a catalog, wherein the topic and the catalog comprise data structures corresponding to health care data in a health care business domain of the health care information source.

34. The health care data transfer system of claim 31, wherein the health care information source corresponds to a health care business domain selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

35. The health care data transfer system of claim 31, wherein the portion of health care data is at least one selected from the group consisting of member data, medical claim data, pharmacy claim data, benefit limit data, coverage data, accumulator data, provider data, and primary care provider data.

36. The health care data transfer system of claim 31, wherein the request message comprises an action identifier identifying the action as a get data request and an identifier corresponding to the portion of health care data, and wherein the response message comprises the portion of health care data.

37. The health care data transfer system of claim 36, further comprising:
a health care data repository operatively connected to the health care data access service and configured to store the portion of health care data in the health care data repository.

38. The health care data transfer system of claim 37, further comprising:
a consumer health care application operatively connected to the health care data access service, wherein the consumer uses the consumer health care application to access the portion of health care data.

39. The health care data transfer system of claim 31, wherein the request message further comprises search criteria.

40. The health care data transfer system of claim 31, wherein the request message comprises an action identifier identifying the action as a set data request, an identifier corresponding to the portion of health care data, and the portion of health care data, and wherein the response message comprises one selected from a group consisting of an acknowledgement and an exception.

41. A health care data transfer system comprising:
a first health care information source corresponding to a first health care business domain, wherein the first health care information source comprises a first portion of health care data corresponding to a consumer;
a second health care information source corresponding to a second health care business domain, wherein the second health care information source comprises a second portion of health care data corresponding to the consumer; and
a health care data access service operatively connected to the first health care information source and the second health care information source, wherein the health care data access service comprises functionality to:
receive the first portion of health care data and the second portion of health care data, and
store the first portion of health care data and the second portion of health care data.

42. The health care data transfer system of claim 41, further comprising:
a consumer health care application operatively connected to the health care data access service and configured to access the first portion health care data and the second portion of health care data.

43. The health care data transfer system of claim 42, wherein the health care data access service further comprises functionality to receive, from the consumer health care application, first authentication information corresponding to the first health care information source and second authentication information corresponding to the second health care information source.

44. The health care data transfer system of claim 41, wherein the health care data access system notifies the consumer that the first portion of health care data and the second portion of health care data are stored by the health care data access service.

45. The health care data transfer system of claim 41, wherein the first health care information source is a first health plan provider and the second health care information source is a second health plan provider.

46. The health care data transfer system of claim 41, wherein the first health care information source corresponds to a first health care business domain and the second health care information source corresponds to a second health care business domain.

47. The health care data transfer system of claim 46, wherein the first health care business domain and the second health care business domain are each one selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

48. The health care data transfer system of claim 41, wherein the first portion of health care data and the second portion of health care data are each at least one selected from a group consisting of member data, medical claim data, pharmacy claim data, benefit limit data, coverage data, accumulator data, provider data, and primary care provider data.

49. The health care data transfer system of claim 41, wherein the health care data access service further comprises functionality to receive the first portion of health care data by:
sending a request message comprising an action identifier corresponding to a get data request and an identifier corresponding to the first portion of health care data to the first health care information source; and
receiving a response message corresponding to the request message from the health care information source, the response message comprising the first portion of health care data.

50. The health care data transfer system of claim 49, wherein the action identifier identifies a health care data transfer protocol method selected from a group consisting of get topic data, set topic data, get catalog data and set catalog data, and wherein the first portion of health care data is one selected from a group consisting of a topic and a catalog, wherein the topic and the catalog comprise data structures corresponding to health care data in a health care business domain of the health care information source.

51. The health care data transfer system of claim 41, wherein the health care data access service further comprises functionality to receive the first portion of health care data by:
receiving a request message from the first health care information source, wherein the request message comprises an action identifier corresponding to a set data request, an identifier corresponding to the first portion of health care data, and the first portion of health care data, and
sending a response message corresponding to the request message to the first health care information source.

52. The health care data transfer system of claim 41, wherein the health care data access service receives the first portion of health care data and the second portion of health care data using messages adhering to a health care data transfer protocol.

53. A health care data access service comprising:
a health care data repository configured to store health care data corresponding to a plurality of consumers, wherein the health care data is received from a plurality of health care information sources; and
a health care data import component configured to import the health care data from the plurality of health care information sources using messages adhering to a health care data transfer protocol.

54. The health care data access service of claim 53, wherein the health care data transfer protocol comprises:
a request message used to request an action corresponding to a portion of health care data,
and a response message corresponding to the request message used to return the result of performing the action,
wherein the action is one selected from a group consisting of get topic data, set topic data, and get catalog data and set catalog data, and
wherein the portion of health care data is one selected from a group consisting of a topic and a catalog, wherein the topic and the catalog are data structures corresponding to health care data in a plurality of health care business domains corresponding to the plurality of health care information sources.

55. The health care data access service of claim 53, wherein each health care information source of the plurality of health care information sources corresponds to a health care business domain selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

56. The health care data access service of claim 53, wherein the health care data is at least one selected from a group consisting of member data, medical claim data, pharmacy claim data, benefit limit data, coverage data, accumulator data, provider data, and primary care provider data.

57. A computer readable medium comprising computer program code embodied therein for causing a computer system to transfer health care data between a consumer health care application and a plurality of health care information sources, the computer program code comprising program instructions to:
request a first portion of health care data corresponding to a consumer from a first health care information source of the plurality of health care information sources;
receive the first portion of health care data from the first health care information source;
store the first portion of health care data in a health care data repository;
request a second portion of health care data corresponding to the consumer from a second health care information source of the plurality of health care information sources;
receive the second portion of health care data from the second health care information source;
store the second portion of health care data in the health care data repository; and
access the first portion of health care data and the second portion of health care data from the health care data repository.

58. The computer readable medium of claim 57, wherein accessing the first portion of health care data and the second portion of health care data is by the consumer health care application.

59. The computer readable medium of claim 57, further comprising program instructions to:
receive, from the consumer health care application, first authentication information corresponding to the first health care information source; and
receive, from the consumer health care application, second authentication information corresponding to the second health care information source.

60. The computer readable medium of claim 57, further comprising program instructions to:
notify the consumer that the first portion of health care data and the second portion of health care data are in the health care data repository.

61. The computer readable medium of claim 57, wherein the first health care information source is a first health plan provider and the second health care information source is a second health plan provider.

62. The computer readable medium of claim 57, wherein the first health care information source corresponds to a first health care business domain and the second health care information source corresponds to a second health care business domain.

63. The computer readable medium of claim 62, wherein the first health care business domain and the second health care business domain are each one selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

64. The computer readable medium of claim 57, wherein the first portion of health care data and the second portion of health care data are each at least one selected from a group consisting of member data, medical claim data, pharmacy claim data, benefit limit data, coverage data, accumulator data, provider data, and primary care provider data.

65. A computer readable medium comprising computer program code embodied therein for causing a computer system to transfer health care data between a consumer health care application and a health care information source, the computer program code comprising program instructions to:
send a first request message comprising a first request for performing a first action corresponding to a first portion of health care data;
receive a first response message corresponding to the first request message, wherein the first response message comprises a result of performing the first action; and
process the first response message,
wherein the first request message and the first response message adhere to a health care data transfer protocol.

66. The computer readable medium of claim 65, wherein the first action is one selected from a group consisting of get topic data, set topic data, get catalog data and set catalog data, and wherein the first portion of health care data is one selected from a group consisting of a topic and a catalog, wherein the topic and the catalog comprise data structures corresponding to the first portion of health care data in a health care business domain of the health care information source.

67. The computer readable medium of claim 65, further comprising program instructions to receive authentication information corresponding to the health care information source.

68. The computer readable medium of claim 65, wherein the health care information source corresponds to a health care business domain selected from a group consisting of a health plan business domain, a financial business domain, a patient records business domain, a pharmacy business domain, a laboratory business domain, a medical imaging business domain, a medical device business domain, a provider billing business domain, a medical research/analytics business domain, a patient education business domain, a dental business domain, a vision care business domain, an alternative medical treatment business domain, a physical fitness business domain, a physical therapy business domain, a rehabilitation business domain, an assisted care business domain, a practice management business domain, and a psychology business domain.

69. The computer readable medium of claim 65, wherein the first portion of health care data is at least one selected from a group consisting of member data, medical claim data, pharmacy claim data, benefit limit data, coverage data, accumulator data, provider data, and primary care provider data.

70. The computer readable medium of claim 65, wherein the first request message comprises an action identifier identifying the first action as a get data request and an identifier corresponding to the first portion of health care data; and wherein the first response message comprises the first portion of health care data.

71. The computer readable medium of claim 65, further comprising program instructions to process the first response message by storing the first portion of health care data in a health care data repository.

72. The computer readable medium of claim 65, wherein the consumer health care application accesses the portion of health care data from the health care data repository.

73. The computer readable medium of claim 65, wherein the first request message further comprises search criteria.

74. The computer readable medium of claim 65, wherein
the first request message comprises an action identifier identifying the first action as a set data request, an identifier corresponding to the first portion of health care data, and the first portion of health care data; and
the first response message comprises one selected from a group consisting of an acknowledgement and an exception.

75. The computer readable medium of claim 65, further comprising program instructions to:
receive a second request message, wherein the second request message comprises a request for performing a second action corresponding to a second portion of health care data;
perform the second action; and
generate a second response message corresponding to the second request message, wherein the second response message comprises a result of performing the second action,
wherein the second request message and the second response message adhere to the health care data transfer protocol.

76. The computer readable medium of claim 75, wherein the second request message comprises an action identifier identifying the second action as a get data request and an identifier corresponding to the second portion of health care data; and wherein the second response message comprises the second portion of health care data.

77. The computer readable medium of claim 76, further comprising program instructions to perform the second action by retrieving the second portion of health care data from a health care data repository.

78. The computer readable medium of claim 75, wherein the second request message comprises an action identifier identifying the second action as a set data request, an identifier corresponding to the second portion of health care data, and the second portion of health care data, and wherein the response message comprises one selected from a group consisting of an acknowledgement and an exception.

79. The computer readable medium of claim 75, further comprising program instructions to perform the second action by storing the second portion of health care data in a health care data repository.
